(19) United States
(12) Patent Application Publication
(10) Pub. No.: US 2016/0040857 A1
(43) Pub. Date: Feb. 11, 2016

(54) FLOURESCENCE-EMITTING LIGHT SOURCE UNIT

(71) Applicant: USHIO DENKI KABUSHIKI KAISHA, Tokyo (JP)

(72) Inventors: Masaki Inoue, Hyogo (JP); Seiji Kitamura, Hyogo (JP); Kiyoyuki Kabuki, Hyogo (JP); Akihiko Sugitani, Hyogo (JP)

(21) Appl. No.: 14/821,530

(22) Filed: Aug. 7, 2015

Related U.S. Application Data
(63) Continuation of application No. PCT/JP2014/052647, filed on Feb. 5, 2014.

(30) Foreign Application Priority Data
Feb. 8, 2013 (JP) 2013-022982
Feb. 15, 2013 (JP) 2013-027305
Mar. 29, 2013 (JP) 2013-071183

(51) Int. Cl. F21V 13/08; F21V 9/16

(52) U.S. Cl. CPC F21V 13/08; F21V 9/16

(57) ABSTRACT

A fluorescence-emitting light source unit includes: a wavelength conversion member including a front surface as a light receiving surface to receive excitation light, a phosphor, and a rear surface; and a light reflection surface provided on an outer side of the rear surface. The front surface is provided with a front side cyclic structure. The phosphor is configured to convert the excitation light received in the light receiving surface to fluorescence and to emit the fluorescence. The rear surface is provided with a rear side cyclic structure.

### CROSS REFERENCE TO RELATED APPLICATIONS

This is a continuation of International Application No. PCT/JP2014/052647, filed Feb. 5, 2014, which claims the benefit of Japanese Priority Patent Applications JP2013-022982, filed Feb. 8, 2013, JP2013-027305, filed Feb. 15, 2013, and JP2013-071183, filed Mar. 29, 2013, the entire contents of all of which are incorporated herein by reference.

### BACKGROUND

The invention relates to a fluorescence-emitting light source unit configured to excite a phosphor by means of excitation light, allowing the phosphor to emit fluorescence.

As an existing green light source used in, for example, a projector, there has been known a fluorescence-emitting light source unit configured to apply laser light as excitation light to a phosphor, allowing the phosphor to emit green light as fluorescence. One exemplary fluorescence-emitting light source unit has been known that includes a wavelength conversion member in which a surface of a rotary wheel is coated with a phosphor. Application of laser light in a blue range to the wavelength conversion member allows the phosphor in the wavelength conversion member to generate light in a green range (refer to Japanese Unexamined Patent Application Publication No. 2011-13316).

Specifically, in Japanese Unexamined Patent Application Publication No. 2011-13316, as illustrated in FIG. 17, used is a fluorescence-emitting light source unit as a green light source of a projector device. The fluorescence-emitting light source unit includes a laser light source 71, a fluorescent wheel 72, and a wheel motor 73. The laser light source 71 is configured to emit laser light oscillated in the blue range. The wheel motor 73 is configured to rotate the fluorescent wheel 72. The fluorescent wheel 72 of the fluorescence-emitting light source unit may include a base and a layer of a wavelength conversion member. The base may transmit the laser light from the laser light source 71. The layer of the wavelength conversion member may be configured of a phosphor to be excited by the laser light.

In FIG. 17, the reference numeral 81 designates a collimate lens, and the reference numeral 82 designates a red light source configured of a red light emitting diode. The reference numerals 83A, 83B, 83C, 84A, 84B, and 84C each designate a condenser lens. The reference numeral 85 designates a dichroic mirror configured to transmit light from the green light source and to reflect light from the red light source, and the reference numeral 86 designates an incident lens of a light guide device. The reference numeral 87 designates a reflection mirror, and the reference numeral 88 designates a light guide device.

Another exemplary fluorescence-emitting light source unit includes, for example, as illustrated in FIG. 18, a wavelength conversion member 61, a substrate 62, a barium sulfate layer 63, and a heat dissipation fin 64. The wavelength conversion member 61 may be configured of a phosphor (a YAG sintered body) to be excited by laser light from a laser light source. The substrate 62 may be configured of an AlN sintered body. The heat dissipation fin 64 may be provided on a rear surface of the substrate 62. The wavelength conversion member 61 may be joined to a front surface of the substrate 62 with the barium sulfate layer 63 in between, to form a joined structure. The joined structure may be fixedly provided with respect to the laser light source (refer to Japanese Unexamined Patent Application Publication No. 2011-198560). Application of the laser light in the blue range as the excitation light to the wavelength conversion member 61 allows light in the green range to be generated in the wavelength conversion member 61.

### SUMMARY

According to the invention of this application, there is provided a fluorescence-emitting light source unit including: a wavelength conversion member including a front surface as a light receiving surface to receive excitation light, a phosphor, and a rear surface; and a light reflection surface provided on an outer side of the rear surface. The front surface is provided with a front side cyclic structure. The phosphor is configured to convert the excitation light received in the light receiving surface to fluorescence and to emit the fluorescence. The rear surface is provided with a rear side cyclic structure.

In the fluorescence-emitting light source unit, a cycle of the front side cyclic structure may be preferably of a size in a range in which diffraction of the fluorescence emitted from the phosphor occurs.

A cycle of the rear side cyclic structure may be preferably of a size in a range in which diffraction of the fluorescence emitted from the phosphor occurs.

In the fluorescence-emitting light source unit, the wavelength conversion member may be configured of a fluorescent member including the phosphor.

In the fluorescence-emitting light source unit, the wavelength conversion member may include: a fluorescent member including the phosphor; and one or both of a front side periodic structural layer and a rear side periodic structural layer. The front side periodic structural layer may be provided on a front surface of the fluorescent member and may include the front side cyclic structure. The rear side periodic structural layer may be provided on a rear surface of the fluorescent member and may include the rear side cyclic structure.

A refractive index of the front side periodic structural layer and a refractive index of the rear side periodic structural layer may be equal to or higher than a refractive index of the fluorescent member.

The fluorescence-emitting light source unit includes: a wavelength conversion member including a front surface as a light receiving surface to receive excitation light, a phosphor, and a rear surface as a light diffusing surface; and a light reflection surface provided on an outer side of the rear surface. The front surface is provided with a front side cyclic structure including a plurality of first protrusions arranged periodically. The phosphor is configured to convert the excitation light received in the light receiving surface to fluorescence and to emit the fluorescence. The rear surface is configured of a rough surface.

### BRIEF DESCRIPTION OF THE DRAWINGS

The accompanying drawings are included to provide a further understanding of the invention, and are incorporated in and constitute a part of this specification. The drawings illustrate some example embodiments and, together with the specification, serve to explain the principles of the invention.

FIG. 1 illustrates an overall configuration of one example of a fluorescence-emitting light source unit according to an example embodiment of the invention.

FIG. 2 is a cross-sectional view illustrating a configuration of a fluorescence emitting member in a fluorescence-emitting light source unit according to a first embodiment of the invention.

FIG. 3 schematically illustrates a modification example of a front side cyclic structure in the fluorescence emitting member.

FIG. 4 macroscopically illustrates a change in a refractive index of a medium through which excitation light is propagated in a case in which the excitation light perpendicularly enters a front surface of a wavelength conversion member configured of a fluorescent member; (a) of FIG. 4 is a cross-sectional view illustrating, in an enlarged manner, a part of the fluorescent member, and (b) of FIG. 4 is a graph indicating macro relation between a position in a direction perpendicular to a front surface of the fluorescent member and the refractive index.

FIG. 5 is a cross-sectional view illustrating a configuration of the fluorescence emitting member in another example of the fluorescence-emitting light source unit according to the first embodiment of the invention.

FIG. 6 is a cross-sectional view illustrating a configuration of the fluorescence emitting member in still another example of the fluorescence-emitting light source unit according to the first embodiment of the invention.

FIG. 7 is a cross-sectional view illustrating a configuration of the fluorescence emitting member in still another example of the fluorescence-emitting light source unit according to the first embodiment of the invention.

FIG. 8 is a cross-sectional view illustrating a configuration of a fluorescence emitting member in a fluorescence-emitting light source unit according to a second embodiment of the invention.

FIG. 9 macroscopically illustrates a change in a refractive index of a medium through which excitation light is propagated in a case in which the excitation light perpendicularly enters a front surface of a wavelength conversion member configured of a fluorescent member; (a) of FIG. 9 is a cross-sectional view illustrating, in an enlarged manner, a part of the fluorescent member, and (b) of FIG. 9 is a graph indicating macro relation between a position in a direction perpendicular to a front surface of the fluorescent member and the refractive index.

FIG. 10 schematically illustrates reflection and diffraction generated in fluorescence in the front surface of the fluorescent member.

FIG. 11 is a cross-sectional view illustrating a configuration of a fluorescence emitting member in another example of the fluorescence-emitting light source unit according to the second embodiment of the invention.

FIG. 12 is a cross-sectional view illustrating a configuration of a fluorescence emitting member in still another example of the fluorescence-emitting light source unit according to the second embodiment of the invention.

FIG. 13 is a perspective view illustrating a configuration of a fluorescence emitting member in a fluorescence-emitting light source unit according to a third embodiment of the invention.

FIG. 14 is a cross-sectional view illustrating the fluorescence emitting member illustrated in FIG. 13.

FIG. 15 is a cross-sectional view illustrating a configuration of a fluorescence emitting member in another example of the fluorescence-emitting light source unit according to the third embodiment of the invention.

FIG. 16 is a graph indicating relation between light reflectance at a rear surface of a wavelength conversion member and light extraction efficiency of the wavelength conversion member, obtained in Experimental Example 1-2.

FIG. 17 illustrates one example configuration of an existing fluorescence-emitting light source unit.

FIG. 18 illustrates another example configuration of an existing fluorescence-emitting light source unit.

### DETAILED DESCRIPTION

Some example embodiments of a fluorescence-emitting light source unit according to the invention are described below.

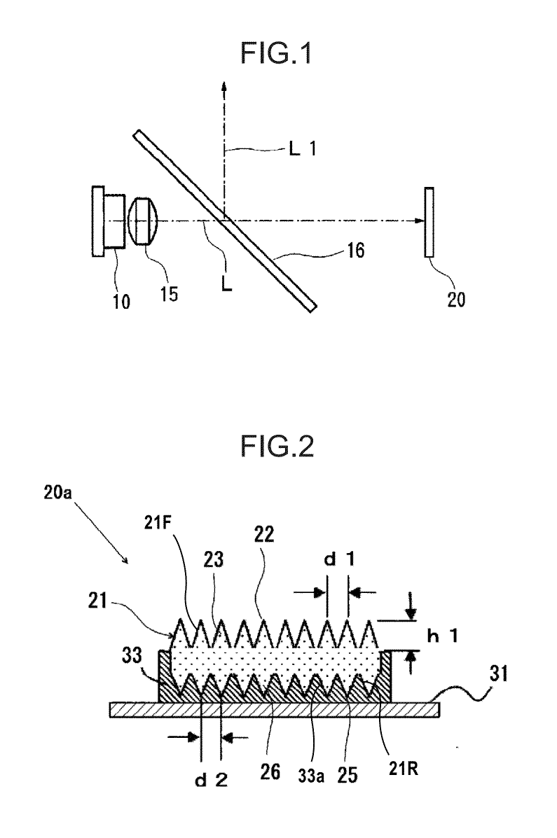

FIG. 1 illustrates an overall configuration of one example of a fluorescence-emitting light source unit according to an example embodiment of the invention.

Referring to FIG. 1, a fluorescence-emitting light source unit may include a laser diode 10 and a fluorescence emitting member 20. The laser diode 10 is configured to emit light in a blue range. The fluorescence emitting member 20 may be disposed to face the laser diode 10, and may include a wavelength conversion member configured of a fluorescent member. The fluorescent member may include a phosphor configured to be excited by excitation light L to emit fluorescence L1 in a green range. The excitation light L may be laser light emitted from the laser diode 10.

A collimator lens 15 may be disposed at a position close to the laser diode 10, between the laser diode 10 and the fluorescence emitting member 20. The collimator lens 15 is configured to allow the excitation light L entering from the laser diode 10 to exit as a parallel beam. A dichroic mirror 16 may be disposed between the collimator lens 15 and the fluorescence emitting member 20, with a posture inclined at an angle of, for example, 45° with respect to an optical axis of the collimator lens 15. The dichroic mirror 16 is configured to transmit the excitation light L from the laser diode 10, and to reflect the fluorescence L1 from the wavelength conversion member in the fluorescence emitting member 20.

Here, FIG. 1 illustrates an example with use of light from one laser diode 10. However, another example may be also possible in which the laser diode 10 may be provided in a plurality, and a condenser lens may be disposed in front of the wavelength conversion member in the fluorescence emitting member 20 to apply condensed light to the wavelength conversion member. Also, the excitation light L is not limited to light by means of the laser diode 10, but may be any light that can excite the phosphor in the wavelength conversion member; condensed LED light may be also possible; furthermore, light from a lamp in which mercury, xenon, etc. is sealed may be possible as well. It is to be noted that, in a case with use of a light source having a wide range of radiation wavelength, such as a lamp or an LED, a wavelength of the excitation light L may be a range of main radiation wavelength. However, the contents of the present invention are not limited thereto.

The overall configuration of the fluorescence-emitting light source unit may be common to all fluorescence-emitting light source units according to first to third embodiments which are described below. The fluorescence-emitting light source units according to the first to the third embodiments may involve respective features in configurations of the fluorescence emitting members 20 (20a to 20c).

The overall configuration of the fluorescence-emitting light source unit is not limited to that illustrated in FIG. 1, but other various configurations may be adopted.

### First Embodiment

FIG. 2 illustrates a cross-sectional configuration of a fluorescence emitting member in a fluorescence-emitting light source unit according to a first embodiment of the invention.

A fluorescence emitting member 20a may include a substrate 31 and a fluorescent member 21, as illustrated in FIG. 2. In one embodiment of the invention, the fluorescent member 21 may serve as a “wavelength conversion member”. The substrate 31 may be rectangular in shape. The fluorescent member 21 may be shaped as a substantially rectangular plate, and may be provided on a front surface (an upper surface in FIG. 2) of the substrate 31.

The fluorescence emitting member 20a may be disposed to allow a front surface 21F (an upper surface in FIG. 2) of the fluorescent member 21 to face the laser diode 10. In one embodiment of the invention, the front surface 21F may serve as a “light receiving surface to receive excitation light”, which is hereinafter simply referred to as an excitation light receiving surface. The front surface 21F may also serve as a fluorescence exiting surface.

A light reflection film 33 may be provided on a rear surface 21R (a lower surface in FIG. 2) and side surfaces of the fluorescent member 21. The light reflection film 33 may be configured of, for example, silver. In one embodiment of the invention, the light reflection film 33 thus provided on the rear surface 21R and the side surfaces of the fluorescent member 21 may allow a light reflection surface 33a to be provided on an outer side of the rear surface 21R and the side surfaces of the fluorescent member 21. On a rear surface of the substrate 31, for example, a heat dissipation fin (not illustrated) may be disposed.

The fluorescent member 21 may constitute a “wavelength conversion member” in one embodiment of the invention, and includes the front surface 21F, i.e., the excitation light receiving surface, and the rear surface 21R. The front surface 21F is provided with a front side cyclic structure 22. In the front side cyclic structure 22, protrusions (hereinafter also called “front side protrusions”) 23 may be periodically arranged on the front surface 21F of the fluorescent member 21, i.e., the excitation light receiving surface. The rear surface 21R is provided with a rear side cyclic structure 25. In the rear side cyclic structure 25, protrusions (hereinafter also called “rear side protrusions”) 26 may be periodically arranged on the rear surface 21R of the fluorescent member 21.

Here, in the specification, a “cyclic structure” may refer to a structure in which periodic structural parts (the protrusions 23 and 26 in FIG. 2) are periodically arranged and the periodic structural parts each have a protruded shape whose diameter decreases as goes toward a rear surface from a front surface.

The fluorescent member 21 may be configured of a single crystal or polycrystalline phosphor. A thickness of the fluorescent member 21 may be, for example, 0.05 mm to 2.0 mm both inclusive.

The single crystal phosphor that constitutes the fluorescent member 21 may be obtained by, for example, the Czochralski method. Specifically, a seed crystal may be allowed to be in contact with a molten material in a crucible. In this state, the seed crystal may be rotated and pulled up vertically, allowing single crystal to be grown on the seed crystal to form the single crystal phosphor.

The polycrystalline phosphor that constitutes the fluorescent member 21 may be obtained, for example, as follows. First, raw materials such as a base material, an activator, a baking auxiliary, etc. may be pulverized with use of a ball mill, etc. to obtain raw material fine particles of submicrometers or smaller. Next, the raw material fine particles may be sintered by, for example, a slip casting method. Thereafter, a sintered body thus obtained may be subjected to hot isotropic pressing to obtain the polycrystalline phosphor whose porosity is equal to or less than, for example, 0.5%.

Specific and not-limiting examples of the phosphors that constitute the fluorescent member 21 may include YAG:Ce, YAG:Pr, YAG:Sm, LuAG:Ce, etc. In such phosphors, a dope amount of a rare earth element may be about 0.5 mol %.

The front side protrusions 23 may constitute the front side cyclic structure 22 formed on the front surface 21F of the fluorescent member 21, and each may preferably be substantially conical in shape, as illustrated in FIG. 2.

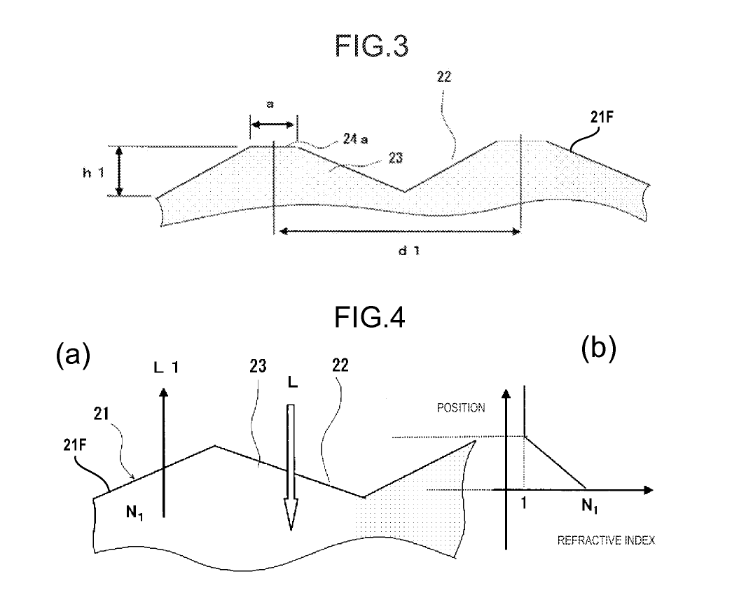

Specifically, a substantially conical shape of the front side protrusions 23 may be a cone as illustrated in FIG. 2 (a circular cone in FIG. 2) or a truncated cone as illustrated in FIG. 3 (a truncated circular cone in FIG. 3). Here, when the front side protrusions 23 are shaped as truncated cones, a dimension (a maximum dimension) a of an upper bottom 24a may be less than the wavelength of the excitation light L. For example, when the front side protrusions 23 are shaped as truncated circular cones, and the wavelength of the excitation light L is 445 nm, the dimension (an outer diameter) of the upper bottom 24a of the protrusion 23 shaped as a truncated circular cone may be 100 nm.

Allowing the front side protrusions 23 to be substantially conical in shape makes it possible to prevent or restrain the excitation light L to be reflected by the front surface 21F of the fluorescent member 21. One reason for such workings may be as follows.

FIG. 4 macroscopically illustrates a change in a refractive index of a medium through which the excitation light L is propagated in a case in which the excitation light L perpendicularly enters the front surface 21F of the fluorescent member 21; (a) of FIG. 4 is a cross-sectional view illustrating, in an enlarged manner, a part of the fluorescent member 21, and (b) of FIG. 4 is a graph indicating macro relation between a position in a direction perpendicular to the front surface 21F of the fluorescent member 21 and the refractive index. As illustrated in FIG. 4, the excitation light L, when applied to the front surface 21F of the fluorescent member 21 (with a refractive index of N₁) from in the air (with a refractive index of 1), enters, in an inclined direction, a tapered surface of the front side protrusion 23 that constitutes the front side cyclic structure 22. Therefore, macroscopically, a refractive index of a medium through which the excitation light L is propagated may change gradually from 1 to N₁ toward a direction perpendicular to the front surface 21F of the fluorescent member 21. Thus, the front surface 21F of the fluorescent member 21 involves substantially no interface at which the refractive index changes drastically, making it possible to prevent or restrain the excitation light L to be reflected by the front surface 21F of the fluorescent member 21.

Moreover, in the substantially conically shaped front side protrusions 23 that constitute the front side cyclic structure 22, an inclination angle of the tapered surface may be preferably equal to or larger than 11°. The inclination angle of the tapered surface may be an angle formed between the tapered surface (a side surface) and a bottom surface.

When the inclination angle of the tapered surface is less than 11°, the tapered surface may be regarded as an interface between two mediums having different refractive indices, leading to possibility of occurrence of reflected light in accordance with a difference between the refractive indices.

Also, in the front side cyclic structure 22, a cycle d1 may be preferably of a size in a range (the Bragg condition) in which diffraction of the fluorescence L1 emitted from the phosphor that constitutes the fluorescent member 21 occurs.

Specifically, the cycle d1 may be preferably a value (hereinafter called an “optical length”) obtained by dividing a peak wavelength of the fluorescence L1 emitted from the phosphor by a refractive index of a constituent material of the front side cyclic structure 22 (the phosphor that constitutes the fluorescent member 21 in FIG. 2). Alternatively, the cycle d1 may be preferably about several times the optical length.

In the invention, the cycle of the cyclic structure may refer to a distance (a center distance) (nm) from one protrusion to another which are adjacent in the cyclic structure.

Allowing the cycle d1 of the front side cyclic structure 22 to be of the size in the range in which the diffraction of the fluorescence L1 generated in the fluorescent member 21 occurs makes it possible to allow the fluorescence L1 to exit to the outside through the front surface 21F of the fluorescent member 21 with high efficiency.

Specific description may be as follows. The fluorescence L1 generated in the fluorescent member 21 may be extracted to the outside through the front surface 21F of the fluorescent member 21 without reflection as transmitted light passing through the front surface 21F of the fluorescent member 21, when an entering angle with respect to the front surface 21F (an interface between the fluorescent member 21 and the air) of the fluorescent member 21 is smaller than a critical angle. On the other hand, when the entering angle of the fluorescence L1 with respect to the front surface 21F of the fluorescent member 21 is equal to or larger than the critical angle, for example, if the front surface of the fluorescent member is a planar surface, the fluorescence may be totally reflected by the front surface of the fluorescent member. The totally reflected light may travel toward inside the fluorescent member, and may be hardly extracted to the outside through the front surface of the fluorescent member. However, the front surface 21F of the fluorescent member 21 is provided with the front side cyclic structure 22 having the cycle d1 satisfying the above-described condition, allowing the fluorescence L1 to be diffracted by the front side cyclic structure 22 in the front surface 21F of the fluorescent member 21. As a result, negative first order diffracted light is allowed to exit through the front surface 21F of the fluorescent member 21 to be extracted to the outside.

An aspect ratio, i.e., a ratio (h1/d1) of a height h1 of the front side protrusion 23 to the cycle d1 in the front side cyclic structure 22 may be preferably equal to or larger than 0.2.

When the ratio (h1/d1) is less than 0.2, a diffraction region may be narrowed in a heightwise direction, making it difficult to obtain sufficient light extraction efficiency by means of diffraction.

The front side cyclic structure 22 may be formed by a nanoimprint method and dry etching. Specifically, a planar front surface of the fluorescent member 21 may be coated with a resist by, for example, a spin coating method. Next, the resist coating film may be patterned by, for example, the nanoimprint method. Thereafter, an exposed region in the front surface of the fluorescent member 21 may be subjected to the dry etching to form the front side cyclic structure 22.

The rear side protrusions 26 may constitute the rear side cyclic structure 25 formed on the rear surface 21R of the fluorescent member 21, and each may be preferably substantially conical in shape, for example, shaped as a circular cone.

Also, a cycle d2 of the rear side cyclic structure 25 may be preferably of a size in a range (the Bragg condition) in which diffraction of the fluorescence L1 emitted from the florescent substance that constitutes the fluorescent member 21 occurs.

Specifically, the cycle d2 of the rear side cyclic structure 25 may be preferably a value (an optical length) obtained by dividing the peak wavelength of the fluorescence L1 emitted from the phosphor by a refractive index of a constituent material of the rear side cyclic structure 25 (the phosphor that constitutes the fluorescent member 21 in FIG. 2). Alternatively, the cycle d2 may be preferably about several times the optical length.

Satisfying this condition allows for an increase in an amount of the fluorescence L1 whose entering angle is smaller than the critical angle, in the fluorescence L1 that is generated in the fluorescent member 21 and enters the front surface 21F of the fluorescent member 21. It is therefore possible to allow the fluorescence L1 generated in the fluorescent member 21 to exit to the outside through the front surface 21F of the fluorescent member 21 with high efficiency.

Specific description may be as follows. The rear surface 21R of the fluorescent member 21 is provided with the rear surface cyclic structure 25 having the cycle d2 satisfying the above-described condition. The rear surface cyclic structure 25 causes diffraction, at the rear surface 21R, of the fluorescence L1 generated in the fluorescent member 21 and entering the rear surface 21R (an interface between the fluorescent member 21 and the light reflection film 33) of the fluorescent member 21 at the entering angle larger than the critical angle. Then, −1 order diffracted light may be reflected by the light reflection film 33 at the rear surface 21R of the fluorescent member 21, toward the front surface 21F of the fluorescent member 21 along a normal direction (a direction perpendicular to the front surface 21F of the fluorescent member 21). Thus, the −1 order diffracted light generated by the diffraction caused by the rear side cyclic structure 25 enters the front surface 21F of the fluorescent member 21 at the entering angle less than the critical angle. This allows for the increase in the amount of the fluorescence L1 whose entering angle is smaller than the critical angle, out of the fluorescence L1 entering the front surface 21F of the fluorescent member 21.

The rear side cyclic structure 25 may be formed by the nanoimprint method and the dry etching, similarly to the front side cyclic structure 22. Specifically, a planar rear surface of the fluorescent member 21 may be coated with a resist by, for example, a spin coating method. Next, the resist coating film may be patterned by, for example, the nanoimprint method. Thereafter, an exposed region in the rear surface of the fluorescent member 21 may be subjected to the dry etching to form the rear side cyclic structure 25.

As a constituent material of the substrate 31, an aluminum substrate may be used, with a heat dissipation adhesive in which metal fine powder is mixed in a resin in between. A thickness of the substrate 31 may be, for example, 0.5 mm to 1.0 mm both inclusive. The aluminum substrate may also serve as a heat dissipation fin.

In the fluorescence-emitting light source unit including the above-described fluorescence emitting member 20a, the excitation light L is emitted from the laser diode 10 as the laser light in the blue range. The excitation light L is allowed to be a parallel beam by the collimator lens 15. Then, the excitation light L passes through the dichroic mirror 16, and is applied substantially perpendicularly to the front surface 21F of the fluorescent member 21, i.e., the excitation light receiving surface of the wavelength conversion member, in the fluorescence emitting member 20a. In the fluorescent member 21, the phosphor that constitutes the fluorescent member 21 is excited to emit the fluorescence L1. The fluorescence L1 exits through the front surface 21F of the fluorescent member 21, i.e., the fluorescence exiting surface of the wavelength conversion member, is reflected perpendicularly by the dichroic mirror 16, and exits to the outside of the fluorescence-emitting light source unit.

In the fluorescence-emitting light source unit, the front surface 21F of the fluorescent member 21, i.e., the excitation light receiving surface of the wavelength conversion member, is provided with the front side cyclic structure 22. Accordingly, when the excitation light L is applied to the front surface 21F of the fluorescent member 21, backscattering of the excitation light L is restrained. As a result, it is possible to take the excitation light L sufficiently into the fluorescent member 21.

Moreover, the rear surface 21R of the fluorescent member 21 is provided with the rear surface cyclic structure 25 as well as the light reflection film 33. Accordingly, the fluorescence L1 emitted from the phosphor in the fluorescent member 21 and entering the rear surface 21R of the fluorescent member 21 is changed in an angle and reflected by the rear surface 21R. Thus, directionality of the fluorescence L1 repetitively reflected in the fluorescent member 21 is allowed to be perpendicular to the front surface 21F of the fluorescent member 21, i.e., the fluorescence exiting surface of the wavelength conversion member. As a result, confinement of the fluorescence L1 in the fluorescent member 21 is restrained, making it possible to extract the fluorescence L1 to the outside through the front surface 21F of the fluorescent member 21 with high efficiency.

In addition, the cycle d1 of the front side cyclic structure 22 and the cycle d2 of the rear side cyclic structure 25 are of the size in the range in which diffraction of the fluorescence L1 generated in the fluorescent member 21 occurs. Hence, it is possible to extract the fluorescence L1 to the outside through the front surface 21F of the fluorescent member 21 with even higher efficiency.

Thus, according to the fluorescence-emitting light source unit, it is possible to take the excitation light L sufficiently into the fluorescent member 21, i.e., the wavelength conversion member, and to allow the fluorescence L1 generated in the fluorescent member 21, i.e., the wavelength conversion member, to exit to the outside with high efficiency. Hence, it is possible to obtain high light emission efficiency.

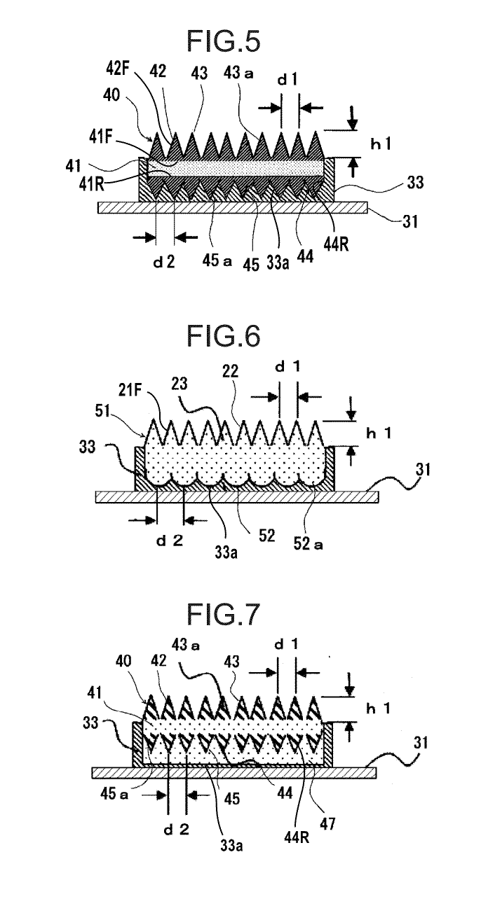

FIG. 5 illustrates a cross-sectional configuration of a fluorescence emitting member in another example of the fluorescence-emitting light source unit according to the first embodiment of the invention.

In the fluorescence-emitting light source unit, the fluorescence emitting member may be configured of a wavelength conversion member 40. The wavelength conversion member 40 may be provided on the substrate 31, as illustrated in FIG. 5. The substrate 31 may be rectangular in shape. The wavelength conversion member 40 may include a fluorescent member 41, a front side periodic structural layer 42, and a rear side periodic structural layer 44. The fluorescent member 41 may be shaped as a rectangular plate. The front side periodic structural layer 42 may be provided on a front surface 41F (an upper surface in FIG. 5) of the fluorescent member 41. The rear side periodic structural layer 44 may be provided on a rear surface 41R (a lower surface in FIG. 5) of the fluorescent member 41. The front side periodic structural layer 42 may be provided with a front side cyclic structure 43 formed in a front surface 42F. The front side cyclic structure 43 may include circular conical protrusions (front side protrusions) 43a arranged periodically. On the other hand, the rear side periodic structural layer 44 may be provided with a rear side cyclic structure 45 formed in a rear surface 44R. The rear side cyclic structure 45 may include circular conical protrusions (rear side protrusions) 45a arranged periodically.

In the wavelength conversion member 40, the front surface 42F (an upper surface in FIG. 5) of the front side periodic structural layer 42 may serve as the excitation light receiving surface and the fluorescence exiting surface.

A light reflection film 33 may be provided on side surfaces of the fluorescent member 41, and the rear surface 44R (a lower surface in FIG. 5) and side surfaces of the rear side periodic structural layer 44. The light reflection film 33 may be configured of, for example, silver. In one embodiment of the invention, the light reflection film 33 thus provided on the side surfaces of the fluorescent member 41, and the rear surface 44R and the side surfaces of the rear side periodic structural layer 44 may allow the light reflection surface 33a to be provided on an outer side of the rear surface 44R and side surfaces of the wavelength conversion member 40. On the rear surface of the substrate 31, for example, a heat dissipation fin (not illustrated) may be disposed. The substrate 31 and the fluorescent member 41 may have similar configurations to those illustrated in FIG. 2 except that no cyclic structures are directly formed in the front surface 41F and the rear surface 41R of the fluorescent member 41.

The front side protrusions 43a may constitute the front side cyclic structure 43 formed on the front surface 42F of the front side periodic structural layer 42. The front side protrusions 43a each may be preferably substantially conical in shape, similarly to the front side cyclic structure 22 in the fluorescent member 21 i.e., the wavelength conversion member, that constitutes the fluorescence emitting member 20a illustrated in FIG. 2. Allowing the front side protrusions 23 to be substantially conical in shape makes it possible to take the excitation light L into the wavelength conversion member 40 with even higher efficiency.

In the front side cyclic structure 43 formed in the front surface 42F of the front side periodic structural layer 42, the cycle d1 may be preferably of the size in the range in which diffraction of the fluorescence L1 emitted from the phosphor that constitutes the fluorescent member 41 occurs. Satisfying this condition makes it possible to allow the fluorescence L1 emitted from the phosphor that constitutes the fluorescent member 41 to be extracted to the outside through the front surface 42F of the front side periodic structural layer 42 with high efficiency.

The aspect ratio, i.e., the ratio of the height h1 of the protrusion 43a to the cycle d1 in the front side cyclic structure 43 of the front side periodic structural layer 42 may be same as that of the front side cyclic structure 22 in the fluorescent member 21, i.e., the wavelength conversion member, that constitutes the fluorescence emitting member 20a illustrated in FIG. 2.

In the rear side cyclic structure 45 formed in the rear surface 44R of the rear side periodic structural layer 44, the cycle d2 may be preferably of the size in the range in which diffraction of the fluorescence L1 emitted from the phosphor that constitutes the fluorescent member 41 occurs. Satisfying this condition makes it possible to allow the fluorescence L1 emitted from the phosphor that constitutes the fluorescent member 41 to be extracted to the outside through the front surface 42F of the front side periodic structural layer 42 with high efficiency.

As a constituent material of the front side periodic structural layer 42 and the rear side periodic structural layer 44 (hereinafter also collectively called “periodic structural layers 42 and 44”), a material whose refractive index is equal to or higher than a refractive index of the fluorescent member 41 may be preferably used. With the periodic structural layers 42 and 44 configured of a material having a refractive index higher than the refractive index of the fluorescent member 41, the fluorescence L1 entering an interface between the fluorescent member 41 and the periodic structural layer 42 or 44 may pass through the interface, causing refraction. This may cause a change in an angle of the fluorescence L1 generated in the wavelength conversion member 40, not only at the rear surface 44R of the wavelength conversion member 40 but also at the interface between the fluorescent member 41 and the periodic structural layer 42 or 44, allowing a direction of the fluorescence L1 to be close to a normal direction (a direction perpendicular to the front surface 42F of the front side periodic structural layer 42). Hence, it is possible to restrain the fluorescence L1 from being confined in the wavelength conversion member 40.

Moreover, the use of the material having the refractive index higher than that of the fluorescent member 41 as the constituent material of the periodic structural layers 42 and 44 makes it possible to form a cyclic structure having a small cycle. This allows for design of the protrusions of the cyclic structure with a small height and a large aspect ratio, contributing to easy formation of the cyclic structure. For example, when using a nanoprint method, formation of a mold (a template) or imprint work may be carried out easily. It is desirable that the constituent material of the periodic structural layers 42 and 44 be an inorganic material, because energy to excite the phosphor in the wavelength conversion member 40 in which the cyclic structure is formed has an excitation density equal to or larger than about 5 W/mm².

As the constituent material of the periodic structural layers 42 and 44, titanium (IV) oxide (titania) (with a refractive index of 2.2), zirconium (IV) oxide (zirconia) (with a refractive index of 1.8), silicon nitride (with a refractive index of 2.0), etc. may be used.

The periodic structural layers 42 and 44 each may have a thickness of, for example, 0.1 μm to 1.0 μm both inclusive.

The periodic structural layers 42 and 44 may be formed with use of a sol-gel method and a nanoimprint method. Specifically, the front surface 41F of the fluorescent member 41 may be coated with a sol material including an alkoxide of titanium, zirconium, etc. by, for example, a spin coating method. The coating may be subjected to heating with a mold (template) die pressed to the coated material. After the die is released, heat treatment may be carried out. The heat treatment may allow a reaction (hydrolysis and condensation polymerization) to progress, to form the periodic structural layers 42 and 44 configured of an inorganic material.

In the fluorescence-emitting light source unit including the above-described fluorescence emitting member, the excitation light L is emitted from the laser diode 10 as the laser light in the blue range. The excitation light L is allowed to be a parallel beam by the collimator lens 15. Then, the excitation light L passes through the dichroic mirror 16, is applied substantially perpendicularly to the front surface 42F of the front side periodic structural layer 42, i.e., the excitation light receiving surface of the wavelength conversion member 40, in the fluorescence emitting member, and enters the fluorescent member 41 through the front side periodic structural layer 42. In the fluorescent member 41, the phosphor that constitutes the fluorescent member 41 is excited to emit the fluorescence L1. The fluorescence L1 exits through the front surface 42F of the front side periodic structural layer 42, i.e., the fluorescence exiting surface of the wavelength conversion member 40, is reflected perpendicularly by the dichroic mirror 16, and exits to the outside of the fluorescence-emitting light source unit.

In the fluorescence-emitting light source unit, the front surface 41F of the fluorescent member 41 in the wavelength conversion member 40 is provided with the front side periodic structural layer 42. The front surface 42F of the front side periodic structural layer 42 may serve as the excitation light receiving surface. The front surface 42F of the front side periodic structural layer 42 is provided with the front side cyclic structure 43. Accordingly, when the excitation light L is applied to the wavelength conversion member 40, backscattering of the excitation light L is restrained. As a result, it is possible to take the excitation light L into the wavelength conversion member 40 with high efficiency.

Moreover, the rear surface 41R of the fluorescent member 41 is provided with the rear side periodic structural layer 44 in which the rear side cyclic structure 45 is formed. On the rear surface 44R of the rear side periodic structural layer 44, the light reflection film 33 is provided. Accordingly, the fluorescence L1 emitted from the phosphor in the wavelength conversion member 40 and entering the rear surface 44R is changed in an angle and reflected by the rear surface 44R. Thus, directionality of the fluorescence L1 repetitively reflected in the wavelength conversion member 40 is allowed to be perpendicular to the front surface 42F, i.e., the fluorescence exiting surface of the wavelength conversion member 40. As a result, confinement of the fluorescence L1 in the wavelength conversion member 40 is restrained, making it possible to extract the fluorescence L1 to the outside through the front surface 42F of the wavelength conversion member 40 with high efficiency.

In addition, the cycle d1 of the front side cyclic structure 43 and the cycle d2 of the rear side cyclic structure 45 are of the size in the range in which diffraction of the fluorescence L1 generated in the wavelength conversion member 40 occurs. Hence, it is possible to extract the fluorescence L1 to the outside through the front surface 42F of the wavelength conversion member 40 with even higher efficiency.

Furthermore, as the constituent material of the periodic structural layers 42 and 44 (the front side periodic structural layer 42 and the rear side periodic structural layer 44), used is the material having the refractive index higher than that of the fluorescent member 41. This allows for refraction of the fluorescence L1 entering the interface between the fluorescent member 41 and the periodic structural layer 42 or 44, causing the fluorescence L1 to be directed closer to the normal direction. Hence, it is possible to extract the fluorescence L1 through the front surface 42F of the front side periodic structural layer 42.

Thus, according to the fluorescence-emitting light source unit using the fluorescence emitting member illustrated in FIG. 5, it is possible to take the excitation light L sufficiently into the wavelength conversion member 40 and to allow the fluorescence L1 generated in the wavelength conversion member 40 to exit to the outside with high efficiency. Hence, it is possible to obtain high light emission efficiency.

Another example of the fluorescence-emitting light source unit according to the first embodiment of the invention includes a wavelength conversion member including a front surface, a phosphor to be excited by excitation light, and a rear surface. The front surface may serve as the excitation light receiving surface, and is provided with a front side cyclic structure. The rear surface may serve as a light diffusing surface, and is configured of a rough surface. A light reflection film may be provided on an outer side of the rear surface.

Here, in the specification, a “rough surface” may refer to an irregularly uneven surface. The irregularly uneven surface may be formed by, for example, roughening treatment such as, but not limited to, mechanical polishing (e.g., blasting, etc.) and chemical polishing (e.g., etching, etc).

One specific example of the above-described fluorescence-emitting light source unit may be configured as follows; in the fluorescence-emitting light source unit illustrated in FIG. 1, the fluorescence emitting member 20 may have a similar configuration to that of the fluorescence emitting member 20a illustrated in FIG. 2 except that a rear surface 21R of a fluorescent member 21 that constitutes a wavelength conversion member is a light diffusing surface configured of a rough surface.

In the fluorescence-emitting light source unit including the above-described fluorescence emitting member, the excitation light L is emitted from the laser diode 10 as the laser light in the blue range. The excitation light L is allowed to be a parallel beam by the collimator lens 15. Then, the excitation light L passes through the dichroic mirror 16, and is applied substantially perpendicularly to the front surface 21F of the fluorescent member 21, i.e., the excitation light receiving surface of the wavelength conversion member. In the wavelength conversion member, the phosphor that constitutes the fluorescent member 21 in the wavelength conversion member is excited to emit the fluorescence L1. The fluorescence L1 exits through the front surface 21F of the fluorescent member 21, i.e., the fluorescence exiting surface of the wavelength conversion member, is reflected perpendicularly by the dichroic mirror 16, and exits to the outside of the fluorescence-emitting light source unit.

In the fluorescence-emitting light source unit, the front surface 21F of the fluorescent member 21, i.e., the excitation light receiving surface of the wavelength conversion member, is provided with the front side cyclic structure 22. Accordingly, when the excitation light L is applied to the fluorescent member 21, backscattering of the excitation light L is restrained. As a result, it is possible to take the excitation light L into the fluorescent member 21 with high efficiency.

Moreover, the rear surface 21R of the fluorescent member 21 on which the light reflection film 33 is provided is a light diffusing surface configured of a rough surface. Accordingly, the fluorescence L1 emitted from the phosphor in the fluorescent member 21 and entering the rear surface 21R of the fluorescent member 21 is reflected at various angles. Thus, directionality of the fluorescence L1 repetitively reflected in the fluorescent member 21 is allowed to be perpendicular to the front surface 21F of the fluorescent member 21, i.e., the fluorescence exiting surface of the wavelength conversion member. As a result, confinement of the fluorescence L1 in the fluorescent member 21 is restrained, making it possible to extract the fluorescence L1 to the outside through the front surface 21F of the fluorescent member 21 with high efficiency.

Thus, according to the fluorescence-emitting light source unit, it is possible to take the excitation light L sufficiently into the fluorescent member 21, i.e., the wavelength conversion member, and to allow the fluorescence L1 generated in the fluorescent member 21, i.e., the wavelength conversion member, to exit to the outside with high efficiency. Hence, it is possible to obtain high light emission efficiency.

Although description has been made by giving the first embodiment as mentioned above, the contents of the invention are not limited to the above-mentioned example embodiment and may be modified in a variety of ways.

For example, in the fluorescence-emitting light source unit according to the first embodiment, the rear side cyclic structure in the wavelength conversion member is not limited to the rear side cyclic structure 25 including substantially conical protrusions 26, but may include protrusions with other structures, as long as the protrusions each have a protruded shape whose diameter decreases as goes toward a rear surface from a front surface.

Specifically, the fluorescence-emitting light source unit according to the first embodiment may include the wavelength conversion member whose rear side cyclic structure includes, for example, semispherical protrusions illustrated in FIG. 6.

Here, the fluorescence emitting member illustrated in FIG. 6 may have a similar configuration to that of the fluorescence emitting member 20a illustrated in FIG. 2, except that the wavelength conversion member may be configured of a fluorescent member 51 including a rear side cyclic structure 52 configured of protrusions (rear side protrusions) 52a each having a semispherical shape.

In the fluorescence-emitting light source unit including the fluorescence emitting member illustrated in FIG. 6, the cycle d2 of the rear side cyclic structure 52 may be of the size in the range in which diffraction of the fluorescence L1 emitted from the phosphor that constitutes the fluorescent member 51 occurs. Satisfying this condition makes it possible to allow the fluorescence L1 emitted from the phosphor that constitutes the fluorescent member 51 to be extracted to the outside through the front surface of the fluorescent member 51, i.e., the wavelength conversion member, with high efficiency.

Moreover, in the fluorescence-emitting light source unit according to the first embodiment, referring to FIG. 7, a member 47 having a light transmitting property (hereinafter also called a “stacked member 47”) may be provided continuously with the rear surface 44R of the wavelength conversion member 40 in which the rear side cyclic structure 45 is formed. Thus, the light reflection surface 33a may be spaced apart from the rear surface 44R of the wavelength conversion member 40.

The stacked member 47 may include a cyclic structure on a front surface positioned on the rear surface 44R side of the wavelength conversion member 40. The cyclic structure may conform to the rear side cyclic structure 45 in the wavelength conversion member 40. The stacked member 47 may be joined to the wavelength conversion member 40 by a joint member (not illustrated) having a light transmitting property. Also, the stacked member 47 may have a different refractive index from that of the member in which the rear side cyclic structure 45 is formed, so as to cause refraction at the rear surface 44R of the wavelength conversion member 40, i.e., an interface between the wavelength conversion member 40 and the stacked member 47.

Specifically, in the fluorescence emitting member illustrated in FIG. 7, the wavelength conversion member 40 may include the fluorescent member 41, the front side periodic structural layer 42, and the rear side periodic structural layer 44. The stacked member 47 may be configured of a fluorescent member, and may be joined to the rear surface 44R of the wavelength conversion member 40, by the joint member (not illustrated). A joined structure of the wavelength conversion member 40 and the stacked member 47 may be provided on the rectangular-shaped substrate 31. The light reflection film 33 made of, for example, silver may be provided on a rear surface (a lower surface in FIG. 7) and side surfaces of the joined structure of the wavelength conversion member 40 and the stacked member 47. In one embodiment of the invention, the light reflection film 33 thus provided on the rear surface and the side surfaces of the joined structure of the wavelength conversion member 40 and the stacked member 47 may allow the light reflection surface 33a to be provided on an outer side of the rear surface 44R of the wavelength conversion member 40. On the rear surface of the substrate 31, for example, a heat dissipation fin (not illustrated) may be disposed.

The fluorescence emitting member may have a similar configuration to that of the fluorescence emitting member illustrated in FIG. 5 except that no light reflection film is provided on the rear surface 44R of the rear side periodic structural layer 44 in the wavelength conversion member 40; the wavelength conversion member 40 is provided on the rectangular-shaped substrate 31 with the stacked member 47 interposed therebetween; and the light reflection film 33 is provided on a rear surface and side surfaces of the stacked member 47. The stacked member 47 may be configured of the fluorescent member, and may have a similar configuration to that of the fluorescence emitting member 20a illustrated in FIG. 2 except that no cyclic structure is formed on the rear surface of the stacked member 47.

In the fluorescence-emitting light source unit including the fluorescence emitting member illustrated in FIG. 7, the excitation light L is applied to the wavelength conversion member 40, and enters the fluorescent member 41 in the wavelength conversion member 40. The excitation light L passing through the wavelength conversion member 40 enters the stacked member 47. Thus, the fluorescence L1 (hereinafter also called “first fluorescence”) is generated in the wavelength conversion member 40, while the fluorescence L1 (hereinafter also called “second fluorescence”) is generated in the stacked member 47 as well.

The first fluorescence enters the interface between the rear surface 44R of the wavelength conversion member 40 and the stacked member 47. Part of the first fluorescence is changed in an angle and reflected by the interface, while other part of the first fluorescence passes through the interface, causing refraction. The refracted light enters the stacked member 47. On the other hand, the second fluorescence enters the interface between the rear surface 44R of the wavelength conversion member 40 and the stacked member 47. Part of the second fluorescence is changed in an angle and reflected by the interface, while other part of the second fluorescence passes through the interface, causing refraction. The refracted light enters the wavelength conversion member 40.

In this way, the first fluorescence and the second fluorescence enter the front surface 42F of the wavelength conversion member 40 through the interface between the stacked member 47 and the rear side periodic structural layer 44 and/or the interface between the fluorescent member 41 and the periodic structural layer 42 or 44 (the front side periodic structural layer 42 or the rear side periodic structural layer 44). Accordingly, the first fluorescence and the second fluorescence are changed in angles by passing through the interfaces in the wavelength conversion member 40. This allows the first fluorescence and the second fluorescence to enter the front surface 42F of the wavelength conversion member 40 at various angles, restraining confinement of the first fluorescence and the second fluorescence in the wavelength conversion member 40.

In the fluorescence-emitting light source unit according to the first embodiment of the invention, the wavelength conversion member is not limited to the wavelength conversion member 40 including the fluorescent member 41, the front side periodic structural layer 42, and the rear side periodic structural layer 44, as illustrated in FIG. 5. The wavelength conversion member may have other configurations as long as the wavelength conversion member includes one or both of the front side periodic structural layer 42 and the rear side periodic structural layer 44, together with the fluorescent member 41.

Specifically, the fluorescence-emitting light source unit may include a wavelength conversion member including, for example, the fluorescent member 41 and the front side periodic structural layer 42. The front surface 42F of the front side periodic structural layer 42 may serve as the excitation light receiving surface. The rear surface 41R of the fluorescent member 41 may be provided with a rear side cyclic structure similar to the rear side cyclic structure 25 illustrated in FIG. 2. The light reflection film 33 may be provided on the rear surface 41R of the fluorescent member 41.

In another alternative, the fluorescence-emitting light source unit may include a wavelength conversion member including the fluorescent member 41 and the rear side periodic structural layer 44. The front surface 41F of the fluorescent member 41 may be provided with a front side cyclic structure similar to the front side cyclic structure 22 illustrated in FIG. 2, and may serve as the excitation light receiving surface. The light reflection film 33 may be provided on the rear surface 44R of the rear side periodic structural layer 44.

In the fluorescence-emitting light source unit according to the first embodiment of the invention, the wavelength conversion member is not limited to a configuration in which the wavelength conversion member is configured of the fluorescent member 21; the front surface 21F of the fluorescent member 21 may serve as the excitation light receiving surface; and the rear surface 21R of the fluorescent member 21 is a light diffusing surface configured of a rough surface. The wavelength conversion member may have other configurations as long as the front surface that may serve as the excitation light receiving surface is provided with the front side cyclic structure, and the rear surface is a light diffusing surface configured of a rough surface.

Specifically, the fluorescence-emitting light source unit may include a wavelength conversion member including, for example, the fluorescent member 41 and the front side periodic structural layer 42. The front surface 42F of the front side periodic structural layer 42 may serve as the excitation light receiving surface. The rear surface 41R of the fluorescent member 41 may be a light diffusing surface configured of a rough surface. The light reflection film 33 may be provided on the rear surface 41R of the fluorescent member 41.

In another alternative, the fluorescence-emitting light source unit may include a wavelength conversion member including the fluorescent member 41 and a rear side rough surface layer. The rear side rough surface layer may be provided on the rear surface 41R of the fluorescent member 41. A rear surface of the rear side rough surface layer may serve as a light diffusing surface configured of a rough surface.

### Second Embodiment

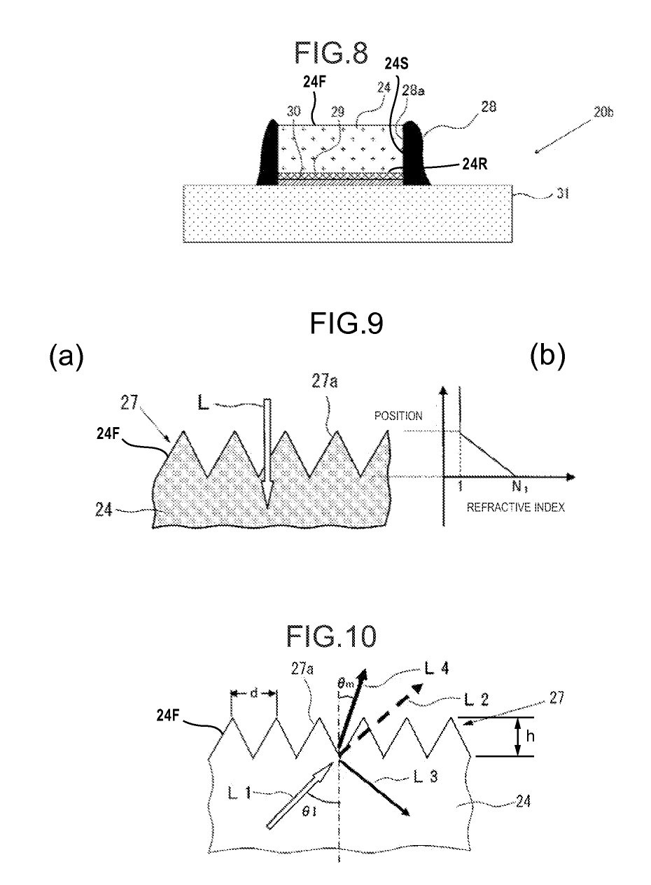

FIG. 8 illustrates a cross-sectional configuration of a fluorescence emitting member in a fluorescence-emitting light source unit according to a second embodiment of the invention.

A fluorescence emitting member 20b may include the substrate 31 and a fluorescent member 24, as illustrated in FIG. 8. The substrate 31 may be rectangular in shape. The fluorescent member 24 may be shaped as, for example, a rectangular plate, and may be provided on the front surface of the substrate 31. In one embodiment of the invention, the fluorescent member 24 may serve as a “wavelength conversion member”.

In the fluorescence emitting member 20b according to this example embodiment, a front surface 24F (an upper surface in FIG. 8) of the fluorescent member 24 as the wavelength conversion member may serve as the excitation light receiving surface. The front surface 24F of the fluorescent member 24 as the wavelength conversion member may also serve as the fluorescence exiting surface, as well as the excitation light receiving surface.

In this example embodiment, referring to FIG. 9, the front surface 24F of the fluorescent member 24, i.e. the excitation light receiving surface of the wavelength conversion member, may be provided with a cyclic structure 27. The cyclic structure 27 may include conical protrusions 27a arranged periodically, as illustrated in FIG. 9. The conical protrusions 27a each may have a diameter decreasing as goes toward a front surface from a rear surface.

A reflection member 28 may be provided on a peripheral side surface 24S of the fluorescent member 24, i.e., the wavelength conversion member. The reflection member 28 may be disposed so as to allow a reflection surface 28a of the reflection member 28 to face the peripheral side surface 24S of the fluorescent member 24. On the rear surface of the substrate 31, for example, a heat dissipation fin (not illustrated) may be disposed.

A light reflection film 29 may be provided on a rear surface 24R (a lower surface in FIG. 8) of the fluorescent member 24, i.e., the wavelength conversion member in this example embodiment. The light reflection film 29 may be configured of a dielectric multi-layered film.

As the constituent material of the substrate 31, an aluminum substrate may be used, with a heat dissipation adhesive in which metal fine powder is mixed in a resin in between. The thickness of the substrate 31 may be, for example, 0.5 mm to 1.0 mm both inclusive. The aluminum substrate may also serve as a heat dissipation fin.

The fluorescent member 24 may be configured of a single crystal or polycrystalline phosphor. A thickness of the fluorescent member 24 may be, for example, 0.05 mm to 2.0 mm both inclusive.

The single crystal phosphor that constitutes the fluorescent member 24 may be obtained by, for example, the Czochralski method. Specifically, a seed crystal may be allowed to be in contact with a molten material in a crucible. In this state, the seed crystal may be rotated and pulled up vertically, allowing single crystal to be grown on the seed crystal to form the single crystal phosphor.

The polycrystalline phosphor that constitutes the fluorescent member 24 may be obtained, for example, as follows. First, raw materials such as a base material, an activator, a baking auxiliary, etc. may be pulverized with use of a ball mill, etc. to obtain raw material fine particles of submicrometers or smaller. Next, the raw material fine particles may be sintered by, for example, a slip casting method. Thereafter, a sintered body thus obtained may be subjected to hot isotropic pressing to obtain the polycrystalline phosphor whose porosity is equal to or less than, for example, 0.5%.

Specific and not-limiting examples of the phosphors that constitute the fluorescent member 24 may include YAG:Ce, YAG:Pr, YAG:Sm, LuAG:Ce, etc. In such phosphors, a dope amount of a rare earth element may be about 0.5 mol %.

The cyclic structure 27 may be formed on the front surface 24F of the fluorescent member 24, and may have a configuration in which substantially conical protrusions 27a are arranged periodically, as illustrated in FIG. 9. The protrusions 27a each may have a diameter decreasing as goes toward a front surface from a rear surface.

In the invention, the cycle of the cyclic structure may refer to a distance (a center distance) (nm) from one protrusion to another which are adjacent in the cyclic structure.

Providing the cyclic structure 27 on the front surface 24F of the fluorescent member 24, i.e., the excitation light receiving surface of the wavelength conversion member, makes it possible to prevent or restrain the excitation light L from being reflected by the front surface 24F of the fluorescent member 24. One reason for generating such workings may be as follows.

FIG. 9 macroscopically illustrates a change in a refractive index of a medium through which the excitation light L is propagated in a case in which the excitation light L perpendicularly enters the front surface 24F of the fluorescent member 24; (a) of FIG. 9 is a cross-sectional view illustrating, in an enlarged manner, a part of the florescent member 24, and (b) of FIG. 9 is a graph indicating macro relation between a position in a direction perpendicular to the front surface 24F of the fluorescent member 24 and the refractive index. As illustrated in FIG. 9, the excitation light L, when applied to the front surface 24F of the fluorescent member 24 (with a refractive index of N₁) from in the air (with a refractive index of 1), enters, in an inclined direction, a tapered surface of the conical protrusion 27a that constitutes the cyclic structure 27. Therefore, macroscopically, a refractive index of a medium through which the excitation light L is propagated may change gradually from 1 to N₁ toward a direction perpendicular to the front surface 24F of the fluorescent member 24. Thus, the front surface 24F of the fluorescent member 24 involves substantially no interface at which the refractive index changes drastically, making it possible to prevent or restrain the excitation light L to be reflected by the front surface 24F of the fluorescent member 24.

On the other hand, in a case without the cyclic structure 27, the tapered surface may be regarded as an interface of two mediums having different refractive indices, leading to possibility of occurrence of reflected light in accordance with a difference between the refractive indices.

A cycle d of the cyclic structure 27 may be preferably of the size in the range (the Bragg condition) in which diffraction of the fluorescence L1 emitted from the phosphor that constitutes the fluorescent member 24 occurs. Specifically, the cycle d of the cyclic structure 27 may be preferably a value (hereinafter called an “optical length”) obtained by dividing a peak wavelength of the fluorescence L1 emitted from the phosphor by a refractive index of a constituent material of the cyclic structure 27 (the phosphor that constitutes the fluorescent member 24 in the example illustrated in the figure). Alternatively, the cycle d of the cyclic structure 27 may be preferably about a value near the optical length.

Satisfying this condition makes it possible to allow the fluorescence L1 emitted from the phosphor that constitutes the fluorescent member 24 to exit to the outside through the front surface 24F of the fluorescent member 24 with high efficiency. Specific description may be as follows. Referring to FIG. 10, when the fluorescence L1 generated in the fluorescent member 24 enters the front surface 24F of the fluorescent member 24 (an interface between the fluorescent member 24 and the air) at an entering angle θI smaller than a critical angle, transmitted light L2 passing through the front surface 24F of the fluorescent member 24 may be extracted to the outside without reflection through the front surface 24F of the fluorescent member 24. On the other hand, when the fluorescence L1 enters the front surface 24F of the fluorescent member 24 at the entering angle θI equal to or larger than the critical angle, for example, if the front surface 24F of the fluorescent member 24 is a planar surface, the fluorescence L1 may be totally reflected by the front surface 24F of the fluorescent member 24. Reflected light L3 thus totally reflected may travel toward inside the fluorescent member 24, and may be hardly extracted to the outside through the front surface 24F of the fluorescent member 24. However, the front surface 24F of the fluorescent member 24 is provided with the cyclic structure 27 having the cycle d satisfying the above-described condition, allowing the fluorescence L1 to be diffracted by the cyclic structure 27 in the front surface 24F of the fluorescent member 24. As a result, negative first order diffracted light L4 is allowed to exit through the front surface 24F of the fluorescent member 24 at an exiting angle θm (θm<θI) to be extracted to the outside.

A ratio (hid), i.e., an aspect ratio, of a height h of the protrusion 27a to the cycle d in the cyclic structure 27 may be preferably equal to or larger than 0.2; more preferably, 0.2 to 1.5 both inclusive; even more preferably, 0.5 to 1.0 both inclusive. When the aspect ratio (h/d) is less than 0.2, a diffraction region may be narrowed in a heightwise direction, making it difficult to obtain sufficient light extraction efficiency by means of diffraction.

The cyclic structure 27 may be formed by a nanoimprint method and dry etching. Specifically, the front surface of the fluorescent member 24 may be coated with a resist by, for example, a spin coating method. Next, the resist coating film may be patterned by, for example, the nanoimprint method. Thereafter, an exposed region in the front surface of the fluorescent member 24 may be subjected to the dry etching to form the cyclic structure 27.

The light reflection film 29 may be formed on the rear surface 24R of the fluorescent member 24, and may be configured of a dielectric multi-layered film.

Specific and non-limiting examples may include a two-layer structure of silver (Ag) plus (+) a reflection enhancing protective film (SiO₂ or Al₂O₃), an alternatively stacked structure of silicon dioxide (silica) (SiO₂) layers and titanium (IV) oxide (titania) (TiO₂) layers, and an alternatively stacked structure of aluminum nitride (AlN) layers and aluminum oxide (Al₂O₃) layers. A constituent material of the dielectric multi-layered film may be selected from AlN, SiO₂, SiN, ZrO₂, SiO, TiO₂, Ta₂O₃, Nb₂O₅, etc.

For example, in the dielectric multi-layered films having combinations of SiO₂/Ta₂O₃, SiO₂/Nb₂O₅, and SiO₂/TiO₂, relation of refractive indices of TiO₂, Nb₂O₅, and Ta₂O₃ is TiO₂>Nb₂O₅>Ta₂O₃, and a total thickness of SiO₂ becomes smallest in the dielectric multi-layered film having the combination of SiO₂/TiO₂. Thus, thermal resistance of the dielectric multi-layered film is reduced, and thermal conduction is improved.

It is therefore preferable that the alternatively stacked structure of aluminum nitride (AlN) layers and aluminum oxide (Al₂O₃) layers be used. With the use of the dielectric multi-layered film in which aluminum nitride (AlN) layers and aluminum oxide (Al₂O₃) layers are alternatively stacked, thermal conductivity of the dielectric multi-layered film is further improved, making it possible to restrain an increase in a temperature of the fluorescent member 24, i.e., the wavelength conversion member. Hence, it is possible to restrain reduction in a light amount due to temperature quenching.

The light reflection film 29 configured of the dielectric multi-layered film is provided on the rear surface 24R of the fluorescent member 24, i.e., the wavelength conversion member. This makes it possible to allow the fluorescence L1 generated in the fluorescent member 24, i.e., the wavelength conversion member to be extracted with higher efficiency, as compared to a case in which a silver single-layer film is provided on the rear surface 24R of the fluorescent member 24, i.e., the wavelength conversion member, because the dielectric multi-layered film has higher reflectance than that of a silver single-layer film.

Also, the dielectric multi-layered film is less affected by sulfuration or oxidation, as compared to a silver single-layer film, and no protective film such as SiO₂, etc is necessary. This allows for a simple configuration and high weather resistance. Hence, it is possible to restrain reduction in extraction efficiency of the fluorescence L1 generated in the fluorescent member 24, i.e., the wavelength conversion member.

A thickness and reflectance of the light reflection film 29 may be as follows. When the light reflection film 29 is configured of the dielectric multi-layered film having a combination of SiO₂/TiO₂, the total number of layers may be 69. A total thickness of the SiO₂ layers may be 3.3 μm. A total thickness of the TiO₂ layers may be 1.8 μm. A thickness of the dielectric multi-layered film may be 5 It is possible to obtain reflectance of 98% or more, in a wavelength range of 425 nm to 600 nm both inclusive.

Moreover, the fluorescence emitting member 20b may be preferably provided with a joint member layer 30 on a whole rear surface (a lower surface in FIG. 8) of the light reflection film 29 with an evaporated film (not illustrated) in between, from a viewpoint of joinability with the substrate 31, etc. The evaporated film may be deposited by evaporation, and may be configured of Cr/Ni/Au with respective thicknesses of 30 nm/500 nm/500 nm, Ti/Ni/Au with respective thicknesses of 30 nm/500 nm/500 nm, etc. At this occasion, the use of titanium (Ti) as an adhesive film to the light reflection film 29 (the dielectric multi-layered film) makes it possible to improve adhesion to the dielectric multi-layered film, as compared to a case with the use of chromium (Cr).

The joint member layer 30 may be configured of solder, a silver (Ag) sintered material, a silver (Ag) epoxy adhesive material, etc. At this occasion, when the joint member layer 30 is configured of solder, a film of Ti/Pt/Au with respective thicknesses of 30 nm/500 nm/500 nm may be preferably formed as a film in contact with the joint member layer 30 in the evaporated film, making it possible to allow platinum (Pt) to restrain diffusion of tin (Sn) in the solder. As a result, it is possible to obtain sufficient long-term reliability of the joint member layer 30. Furthermore, when using a solder having a higher melting point, a configuration in which Ti/Pt may be stacked with gold (Au) stacked as a final film may be possible.

In the fluorescence emitting member 20b, the reflection member 28 may be provided on the peripheral side surface 24S of the fluorescent member 24, i.e., the wavelength conversion member. The reflection member 28 may be so disposed as to allow the reflection surface 28a to face the peripheral side surface 24S. More preferably, the reflection surface 28a may be a diffusion reflection surface.

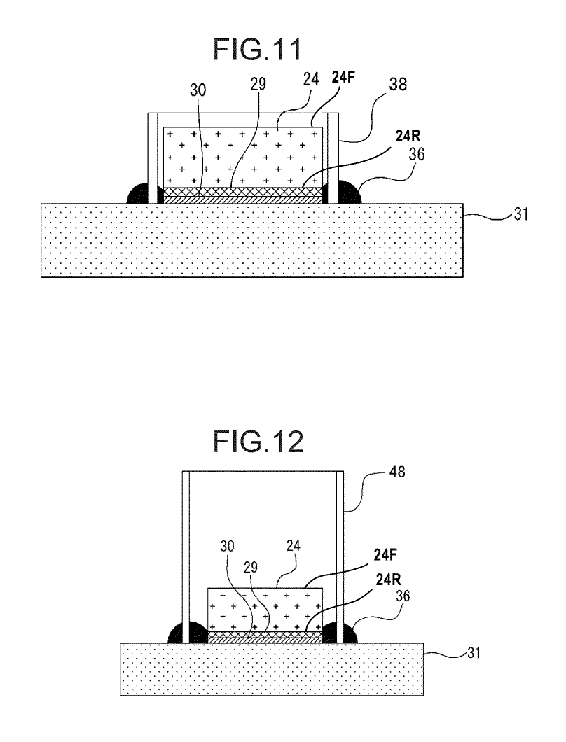

In the invention, the reflection member 28 may be in contact with the fluorescent member 24, i.e., the wavelength conversion member. Alternatively, as illustrated in FIG. 11, a reflection member 38 may be spaced apart from the peripheral side surface 24S of the fluorescent member 24, i.e., the wavelength conversion member. In FIG. 11, the reflection member is denoted by the reference numeral 38.

Preferably, the reflection member 38 may be level with at least the fluorescent member 24, i.e., the wavelength conversion member (refer to FIG. 11). However, as illustrated in FIG. 12, a reflection member 48 may extend heightwise beyond the fluorescent member 24, i.e., the wavelength conversion member. Such configuration makes it possible to apply the laser light as the excitation light L surely to the front surface 24F of the fluorescent member 24, i.e., the excitation light receiving surface of the wavelength conversion member. In FIG. 12, the reflection member is denoted by the reference numeral 48.

When the reflection surface 28a is a mirror reflection surface, for example, a cylindrical mirror reflection member may be used as the reflection member 28. Examples of the cylindrical mirror reflection member may include cylindrical glass with a silver thin film formed on its inner surface, a plurality of reflection plates combined to form an angular cylinder and joined with an adhesive such as an epoxy resin, etc. Non-limited examples of the reflection plate may include a high glittering aluminum plate, silver (Ag) plus (+) a reflection enhancing protective film (SiO₂ or Al₂O₃), an aluminum plate with a dielectric multi-layered film formed on its surface, etc.

The cylindrical mirror reflection member may be fixed to the substrate 31 with an adhesive layer 36 configured of a silicone resin, an epoxy resin, ceramic, etc.

The adhesive layer 36 to fix the cylindrical mirror reflection member may be configured of a material of the reflection member 28, which is described later. When the cylindrical mirror reflection member is fixed with use of such a reflection material, the fluorescence entering the adhesive layer 36 may be also diffusion reflected, making it possible to extract the fluorescence with high efficiency. Moreover, the fluorescence is allowed to re-enter the fluorescent member 24, i.e., the wavelength conversion member, with a change in a direction of light, making it possible to extract the fluorescence with high efficiency.

When the reflection surface 28a is a diffusion reflection surface, the reflection member 28 may be configured of a cured material or a sintered material of a dispersion of aluminum oxide (Al₂O₃), titanium (IV) oxide (titania) (TiO₂), or barium sulfate of several micrometers or of nano order in silicone or a glass paste.

When the reflection member 28 is in contact with the fluorescent member 24, i.e., the wavelength conversion member, the reflection member 28 may be formed as follows. The peripheral side surface 24S of the florescent member 24, i.e., the wavelength conversion member, may be coated with the above-described material, in a state in which a coating is in contact with the peripheral side surface. Thereafter, the coating may be cured or fired to obtain the reflection member 28.

On the other hand, when the reflection member 28 is spaced apart from the fluorescent member 24, i.e., the wavelength conversion member, the reflection member 28 may be formed as follows. The above-described material may be cured or fired separately in an appropriate shape. Then, the material thus cured or fired may be fixed to the substrate 31 with the adhesive layer 36. The adhesive layer 36 may be configured of a silicone resin, an epoxy resin, ceramic, low melting point glass, a sol-gel, etc.

Reflectance of the reflection surface 28a may be preferably equal to or higher than 98%.

The reflection member 28 is provided so as to surround the peripheral side surface 24S of the fluorescent member 24, i.e., the wavelength conversion member. This makes it possible to allow the fluorescence L1 exiting through the peripheral side surface 24S of the fluorescent member 24, i.e., the wavelength conversion member, to be reflected by the reflection surface 28a to return into an inside of the fluorescent member 24, i.e., the wavelength conversion member. Hence, it is possible to allow the fluorescence L1 generated in the fluorescent member 24, i.e., the wavelength conversion member, to be extracted with even higher efficiency.

Moreover, the reflection surface 28a is a diffusion reflection surface. Accordingly, the fluorescence L1 exiting through the peripheral side surface 24S of the fluorescent member 24, i.e., the wavelength conversion member, is changed in a direction by diffusion reflection when returned into the inside of the fluorescent member 24, i.e., the wavelength conversion member. This allows the fluorescence L1 to be easily extracted in a front direction of the fluorescent member 24, i.e., the wavelength conversion member (a direction toward the excitation light receiving surface). Hence, it is possible to allow the fluorescence L1 generated in the fluorescent member 24, i.e., the wavelength conversion member to be extracted with higher efficiency.

In the fluorescence-emitting light source unit including the above-described fluorescence emitting member 20b, the excitation light L is emitted from the laser diode 10 as the laser light in the blue range. The excitation light L is allowed to be a parallel beam by the collimator lens 15. Then, the excitation light L passes through the dichroic mirror 16, and is applied substantially perpendicularly to the front surface 24F of the fluorescent member 24, i.e., the excitation light receiving surface of the wavelength conversion member. In the fluorescent member 24, the phosphor that constitutes the fluorescent member 24 is excited to emit the fluorescence L1. The fluorescence L1 exits through the front surface 24F of the fluorescent member 24, is reflected perpendicularly by the dichroic mirror 16, and exits to the outside of the fluorescence-emitting light source unit.

It is to be noted that the laser light emitted from the laser diode 10 is used as the excitation light L in the present example embodiment, however, the excitation light L is not limited to the laser light of the laser diode 10 but may be any other light that can excite the phosphor. For example, condensed LED light may be also possible. Furthermore, the excitation light L may be light from a discharge lamp, etc. in which mercury, a xenon gas, etc. is sealed.

In the fluorescence-emitting light source unit, the front surface 24F of the fluorescent member 24, i.e., the excitation light receiving surface of the wavelength conversion member, is provided with the cyclic structure 27. Accordingly, when the excitation light L is applied to the front surface 24F of the fluorescent member 24, i.e., the excitation light receiving surface of the wavelength conversion member, backscattering of the excitation light L is restrained, resulting in high light emission efficiency.

Moreover, the cycle d of the cyclic structure 27 is of the size in the range in which diffraction of the fluorescence L1 emitted from the phosphor that constitutes the fluorescent member 24 occurs. This allows the fluorescence L1 emitted from the phosphor to be extracted to the outside with high efficiency, resulting in higher light emission efficiency.

Furthermore, the light reflection film 29 configured of the dielectric multi-layered film is provided on the rear surface 24R of the fluorescent member 24. This makes it possible to allow the fluorescence L1 generated inside the fluorescent member 24 be extracted with high efficiency, resulting in even higher light emission efficiency.

Although description has been made by giving the second embodiment as mentioned above, the contents of the invention are not limited to the above-mentioned example embodiment and may be modified in a variety of ways.

For example, the wavelength conversion member is not limited to one including only the fluorescent member 24. The wavelength conversion member may be one in which a periodic structural layer is stacked on a front surface of a fluorescent member. The fluorescent member may be shaped as a plate and includes no cyclic structure. A front surface of the periodic structural layer may be provided with a cyclic structure. In a fluorescence emitting member in such an example, the front surface of the periodic structural layer may serve as the excitation light receiving surface.

The cyclic structure formed on the front surface of the periodic structural layer may have a similar shape to that of the cyclic structure 27 formed on the front surface 24F of the fluorescent member 24 in the fluorescence emitting member 20b illustrated in FIG. 8.

As a constituent material of the periodic structural layer, a material whose refractive index is equal to or higher than a refractive index of the fluorescent member may be preferably used. With the periodic structural layer configured of such a material, when the fluorescence enters the periodic structural layer through the fluorescent member, an angle of the fluorescence travelling in the periodic structural layer may be smaller than an entering angle, allowing the fluorescence to be directed closer to a normal direction of an exiting surface. Hence, it is possible to extract the fluorescence more easily.

Configurations of a substrate, a fluorescent member, a light reflection film, a joint member layer, and a reflection member may be similar to those illustrated in FIG. 8 except that no cyclic structure is directly provided on the front surface of the fluorescent member.

### Third Embodiment

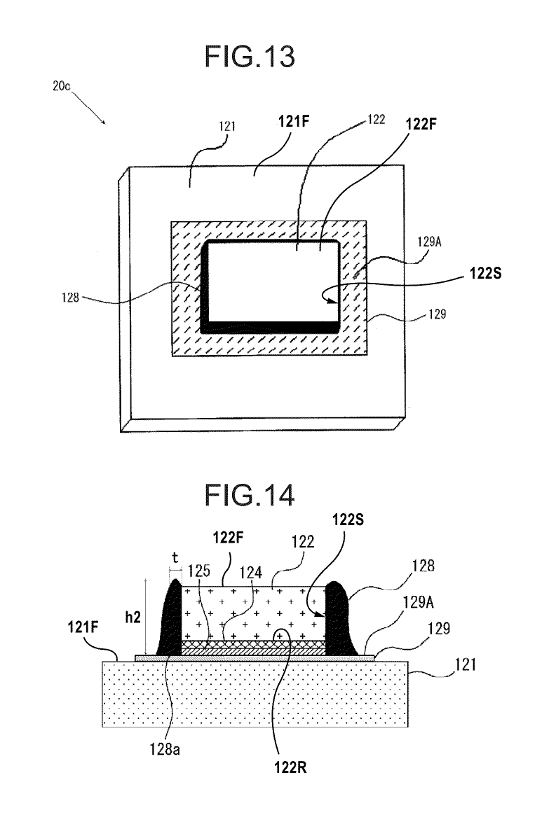

FIG. 13 is a perspective view illustrating a configuration of a fluorescence emitting member in a fluorescence-emitting light source unit according to a third embodiment of the invention. FIG. 14 illustrates a cross-section of the fluorescence emitting member illustrated in FIG. 13.

Referring to FIG. 13, a fluorescence emitting member 20c includes a substrate 121, a wavelength conversion member 122, a joining metal layer 129, and a reflection layer 128. The wavelength conversion member 122 is joined to a front surface 121F of the substrate 121 with the joining metal layer 129 in between. The substrate 121 may be shaped as a rectangular plate. The wavelength conversion member 122 may be configured of a fluorescent member shaped as a rectangular plate. The joining metal layer 129 may be rectangular in shape. The reflection layer 128 covers a peripheral side surface 122S of the wavelength conversion member 122.

In the fluorescence emitting member 20c, a front surface 122F (an upper surface in FIG. 14) of the wavelength conversion member 122 may serve as the excitation light receiving surface. The front surface 122F of the wavelength conversion member 122 may also serve as the fluorescence exiting surface as well as the excitation light receiving surface.

The wavelength conversion member 122 may be configured of a fluorescent member. The fluorescent member may be configured of a single crystal or polycrystalline phosphor.

As the single crystal phosphor, one obtained by, for example, the Czochralski method (the CZ method) as follows may be used. In the CZ method, a seed crystal may be allowed to be in contact with a molten raw material in a crucible. The seed crystal may be maintained vertically, rotated, and pulled up, allowing crystal (single crystal) to be grown.

As the raw material and the seed crystal, various materials and various seed crystals may be used.

As the polycrystalline phosphor, one obtained as follows may be used. For example, raw materials (a base material, a baking auxiliary, and an activator if necessary) may be pulverized with use of a pulverizer such as a ball mill, etc. to a particle diameter of submicrometers or smaller. A sintered body may be formed from raw material fine particles thus obtained, by a slip casting method. Thereafter, the sintered body thus obtained may be subjected to hot isotropic pressing.

As the raw materials, various materials may be used as long as they can be sintered.

As the polycrystalline material, one having porosity equal to or smaller than 0.5% may be preferably used. One reason may be as follows. The single crystal material has no pores, and the polycrystalline material has few pores. Therefore, there is little possibility of significant lowering of thermal conductivity due to existence of the air having low thermal conductivity in the pores.

As the single crystal material and the polycrystalline material, one doped (activated) with a rare earth element as an activator may be preferable.

Non-limiting examples of the rare earth element may include cerium (Ce), praseodymium (Pr), samarium (Sm), etc.

A dope amount of the rare earth element may be appropriately determined in accordance with, for example, a kind of the rare earth element to be doped, etc., and may be, for example, about 0.5 mol %.

Specific and non-limiting examples of the phosphor may include YAG:Ce, YAG:Pr, YAG:Sm, LuAG:Ce, etc. YAG:Ce is a crystalline material of yttrium aluminum garnet (Y₃Al₅O₁₂) doped with cerium. YAG:Pr is a crystalline material of yttrium aluminum garnet (Y₃Al₅O₁₂) doped with praseodymium. YAG:Sm is a crystalline material of yttrium aluminum garnet (Y₃Al₅O₁₂) doped with samarium. LuAG:Ce is a crystalline material of lutetium aluminum garnet (Lu₃Al₅O₁₂) doped with cerium.

The front surface 122F, i.e., the excitation light receiving surface, of the wavelength conversion member 122 is provided with a front side cyclic structure including protrusions arranged periodically. A cycle of the front side cyclic structure may be of the size in the range in which diffraction of fluorescence L1 generated in the phosphor occurs. This makes it possible to allow the fluorescence L1 to exit to the outside through the front surface 122F of the wavelength conversion member 122 with high efficiency.

As a method of forming the cyclic structure, the use of a nanoimprint method makes it possible to carry out formation of a mold (a template) or imprint work easily. Alternatively, the cyclic structure may be formed by deposition on the wavelength conversion member 122 or by direct dry etching of the wavelength conversion member 122.

As a sol-gel material for nanoimprint and a material for deposition, inorganic materials may be desirable, because an excitation light density is about 5 W/mm² or more. Non-limiting examples of the inorganic materials may include YAG, LuAG, ZrO₂, Y₂O₃, In₂O₃, HfO₂, Nb₂O₅, SnO₂, Al₂O₃/La₂O₃, ITO, ZnO, Ta₂O₅, TiO₂, etc.

Preferably, a thickness of the wavelength conversion member 122 may be 30 μm to 200 μm both inclusive; more preferably, 50 μm to 150 μm both inclusive.

When the thickness of the wavelength conversion member 122 is too small, the excitation light passes through the wavelength conversion member 122. This may make it difficult to allow the wavelength conversion member 122 to sufficiently absorb the excitation light, resulting in possibility of reduction in an amount of conversion of the fluorescence. On the other hand, when the thickness of the wavelength conversion member 122 is too large, heat generated by application of the excitation light may be accumulated in the wavelength conversion member 122 due to thermal resistance of the wavelength conversion member 122, leading to high temperatures.

Preferably, a light reflection film 124 may be provided on a rear surface (a lower surface in FIG. 14) of the wavelength conversion member 122, from a viewpoint of light extraction efficiency. The light reflection film 124 may be configured of a dielectric multi-layered film and may be provided on the whole rear surface of the wavelength conversion member 122.

Specific and non-limiting examples of the dielectric multi-layered film may include a two-layer structure of silver (Ag) plus (+) a reflection enhancing protective film (SiO₂ or Al₂O₃), an alternatively stacked structure of silicon dioxide (silica) (SiO₂) layers and titanium (IV) oxide (titania) (TiO₂) layers, and an alternatively stacked structure of aluminum nitride (AlN) layers and aluminum oxide (Al₂O₃) layers. A constituent material of the dielectric multi-layered film may be selected from AlN, SiO₂, SiN, ZrO₂, SiO, TiO₂, Ta₂O₃, Nb₂O₅, etc.

For example, in the dielectric multi-layered films having combinations of SiO₂/Ta₂O₃, SiO₂/Nb₂O₅, and SiO₂/TiO₂, relation of refractive indices of TiO₂, Nb₂O₅, and Ta₂O₃ is TiO₂>Nb₂O₅>Ta₂O₃, and a total thickness of SiO₂ becomes smallest in the dielectric multi-layered film having the combination of SiO₂/TiO₂. Thus, thermal resistance of the dielectric multi-layered film is reduced, and thermal conduction is improved.

It is therefore preferable that the alternatively stacked structure of aluminum nitride (AlN) layers and aluminum oxide (Al₂O₃) layers be used. With the use of the dielectric multi-layered film in which aluminum nitride (AlN) layers and aluminum oxide (Al₂O₃) layers are alternatively stacked, thermal conductivity of the dielectric multi-layered film is further improved, making it possible to restrain an increase in a temperature of the wavelength conversion member 122. Hence, it is possible to restrain reduction in a light amount due to temperature quenching.

The light reflection film 124 configured of the dielectric multi-layered film is provided on the rear surface of the wavelength conversion member 122. This makes it possible to allow the fluorescence generated in the wavelength conversion member 122 to be extracted with high efficiency, as compared to a case in which a silver single-layer film is provided on the rear surface of the wavelength conversion member 122, because the dielectric multi-layered film has higher reflectance than that of a silver single-layer film.

Also, the dielectric multi-layered film is less affected by sulfuration or oxidation, as compared to a silver single-layer film, and no protective film such as SiO₂, etc is necessary. This allows for a simple configuration and high weather resistance. Hence, it is possible to restrain reduction in extraction efficiency of the fluorescence generated in the wavelength conversion member 122.

A thickness and reflectance of the light reflection film 124 may be as follows. When the light reflection film 124 is configured of the dielectric multi-layered film having a combination of SiO₂/TiO₂, the total number of layers may be 69. A total thickness of the SiO₂ layers may be 3.3 μm. A total thickness of the TiO₂ layers may be 1.8 μm. A thickness of the dielectric multi-layered film may be 5 μm. It is possible to obtain reflectance of 98% or more, in a wavelength range of 420 nm to 600 nm both inclusive.

A metal film 125 may be preferably provided on the rear surface 122R side of the wavelength conversion member 122 from a viewpoint of joinability with the joining metal layer 129. In the present embodiment, the metal film 125 may be provided on the whole rear surface of the light reflection film 124. For example, the metal film 125 may be formed by evaporation, and may be configured of a nickel/platinum/gold (Ni/Pt/Au) film, or a nickel/gold (Ni/Au) film.

A thickness of the metal film 125 may be, for example, Ni/Pt/Au with respective thicknesses of 30 nm/500 nm/500 nm.

The substrate 121 may be preferably configured of a material having high thermal conductivity.

Non-limiting examples of a constituent material of the substrate 121 may include aluminum, a graphite plate, aluminum oxide (alumina), a composite material of graphite and aluminum (hereinafter also called a “graphite composite material”), etc.

The graphite composite material may be obtained by a molten metal forging method.

Specifically, the graphite composite material may be produced as follows. A graphite block may be immersed in a molten aluminum metal. The molten aluminum metal may be subjected to high pressure, forcing the molten aluminum metal to be injected and impregnated into pores in the graphite block, and then, the molten aluminum metal may be cooled. With such a production method, it is possible to obtain the graphite composite material as a dense forging with few cavities (holes).

A front surface 121F (an upper surface in FIG. 14) of the substrate 121 may be configured of a metal film (not illustrated), from a viewpoint of joinability with the joining metal layer 129. The metal film may be formed by, for example, a plating method, and may be configured of a nickel/gold (Ni/Au) film. In other words, an outermost surface, i.e., the front surface 121F of the substrate 121 may be configured of a gold (Au) film.

A thickness of the metal film may be, for example, Ni/Au with respective thicknesses of 1000 nm to 5000 nm both inclusive/100 nm to 1000 nm both inclusive.

On a rear surface (a lower surface in FIG. 14) of the substrate 121, for example, a heat dissipation fin (not illustrated) may be disposed.

A thickness of the substrate 121 may be, for example, 1 mm to 3 mm both inclusive.

Area of the front surface 121F (the upper surface in FIG. 14) of the substrate 121 may be preferably larger than area of the rear surface 122R (the lower surface in FIG. 14) of the wavelength conversion member 122, from a viewpoint of a heat exhaust property, etc.

The substrate 121 and the wavelength conversion member 122 are joined with the joining metal layer 129 in between. In the present embodiment, the gold (Au) film that constitutes the front surface 121F of the substrate 121 and the metal film 125 formed on the rear surface 122R side of the wavelength conversion member 122 may be joined together by the joining metal layer 129.

The joining metal layer 129 may have high heat conductivity, and may be configured of a material having high affinity for a material that constitutes the reflection layer 128, which is described later.

Preferably, for example, a material that constitutes the joining metal layer 129 (hereinafter also called a “constituent material of the joining metal layer 129”) may have thermal conductivity of 40 W/mK or more, and may have high affinity (wettability) for a material that constitutes the reflection layer 128, specifically for a silicone resin. Specific and non-limiting examples may include flux-free solder (Sn—Ag—Cu), a silver (Ag) sintered material, a silver (Ag) paste, etc. As the constituent materials of the joining metal layer 129, the solder (Sn—Ag—Cu) has a melting point of 250° C. to 270° C. both inclusive; the silver (Ag) sintered material has a melting point of 180° C. to 220° C. both inclusive; and the silver (Ag) paste has a melting point of 150° C. to 200° C.

In a case with use of the silver (Ag) sintered material as the constituent material of the joining metal layer 129, the joining metal layer 129 may be formed as follows. For example, silver (Ag) nanoparticles may be applied and heated (at 180° C. to 200° C. both inclusive) to be bonded by a solid-state reaction.

In a case with use of the silver (Ag) paste as the constituent material of the joining metal layer 129, the joining metal layer 129 may be formed by applying the silver (Ag) paste and heating (at 120° C. to 210° C. both inclusive).

The joining metal layer 129 includes an uncovered region 129A that is not covered with the wavelength conversion member 122. Specifically, area of a front surface (an upper surface in FIG. 14) of the joining metal layer 129 may be larger than the area of the rear surface 122R (the lower surface in FIG. 14) of the wavelength conversion member 122. In the present embodiment, area of the front surface of the joining metal layer 129 may be larger than area of a rear surface of the metal film 125.

In the present embodiment, the uncovered region 129A may be a rectangular frame-shaped region corresponding to a region of the front surface (the upper surface in FIG. 14) of the joining metal layer 129, excluding a region occupied by the rear surface 122R of the wavelength conversion member 122 (in the present embodiment, the rear surface of the metal film 125).

As to a size and a shape of the uncovered region 129A, the uncovered region 129A may preferably have a shape of a rectangular frame having a width of at least about 1 mm or more from an end of the wavelength conversion member 122.

A thickness of the joining metal layer 129 may be, for example, 20 to 200 μm both inclusive.

Area of a rear surface (a lower surface in FIG. 14) of the joining metal layer 129 may be smaller than the area of the front surface 121F of the substrate 121.

The reflection layer 128 may be provided, on the uncovered region 129A of the joining metal layer 129, so as to cover the whole peripheral side surface 122S of the wavelength conversion member 122.

Specifically, the reflection layer 128 may be adhered to the peripheral side surface 122S of the wavelength conversion member 122, in a state in which the reflection layer 128 is in contact with the peripheral side surface 122S of the wavelength conversion member 122 throughout a whole circumference. The reflection layer 128 may be adhered to the uncovered region 129A of the joining metal layer 129, in a state in which one side surface (a lower surface in FIG. 14) 128a is in contact with the uncovered region 129A.

The side surface 128a of the reflection layer 128 may be in contact with the uncovered region 129A of the joining metal layer 129. A contact surface of the side surface 128a with the uncovered region 129A may serve as a scaffold to fix the reflection layer 128.

The reflection layer 128 may be configured of a material (hereinafter also called a “constituent material of the reflection layer 128”) in which reflection particles are dispersed in a binder.

Non-limiting examples of the binder may include a silicone resin, an aqueous ceramic suspension, low melting point glass, a SiO₂ sol-gel material, etc.

Non-limiting examples of the reflection particles may include aluminum oxide (Al₂O₃), titanium (IV) oxide (titania) (TiO₂), silicon dioxide (silica) (SiO₂), barium sulfate (BaSO₄), zinc oxide (ZnO), etc. One of them may be used alone, or two or more of them may be used in combination. As the reflection particles, titanium (IV) oxide (titania) (TiO₂) may be preferably used from a viewpoint of imparting a diffusion reflection property, while silicon dioxide (silica) (SiO₂) may be preferably used from a viewpoint of imparting a thixotropic property.

A particle diameter of the reflection particles may be, for example, 300 nm to 50 μm both inclusive.

A content ratio of the reflection particles may vary depending on a kind of the reflection particles, and may be 10 mass % or less with respect to the binder, from a viewpoint of adhesion of the reflection layer 128 to the wavelength conversion member 122 and the joining metal layer 129.

Reflectance of the reflection layer 128 may be 95% or more at a wavelength of 450 nm.

The constituent material of the reflection layer 128 has higher affinity for the constituent material of the joining metal layer 129 than for the constituent material of the front surface 121F of the substrate 121. Specifically, the constituent material of the reflection layer 128 has higher affinity for the solder (Sn—Ag—Cu), the silver (Ag) sintered material, the silver (Ag) paste, etc. as the above-described constituent material of the joining metal layer 129 than for gold (Au) as the constituent material of the front surface 121F of the substrate 121. Thus, the reflection layer 128 is surely fixed, with the uncovered region 129A of the joining metal layer 129 serving as a scaffold.

The reflection layer 128 may be formed as follows. The constituent material of the reflection layer 128 in a creamy state or in a gel state may be discharged, on the uncovered region 129A, for quantitative coating with use of a dispenser, allowing a coating to be in contact with the peripheral side surface 122S of the wavelength conversion member 122. Then, the coating may be cured or fired. In this case, a curing temperature may be a temperature lower than a melting point of the constituent material of the joining metal layer 129. The curing temperature may be, for example, 150° C., and a curing time may be, for example, 30 minutes.

Adhesion between the reflection layer 128 and the peripheral side surface 122S of the wavelength conversion member 122 may be either physical adhesion or chemical adhesion. Specifically, the reflection layer 128 may exhibit, with respect to the wavelength conversion member 122, an adhesive property (physical adhesion) due to surface unevenness of the phosphor that constitutes the wavelength conversion member 122, or an adhesive property (chemical adhesion) due to an OH group.

Preferably, a thickness t of the reflection layer 128 may be equal to or larger than, for example, 100 μm; more preferably, 100 μm to 1 mm both inclusive.

It is to be noted that the thickness t of the reflection layer 128 refers to a minimum width in a direction perpendicular to the peripheral side surface 122S of the wavelength conversion member 122 (in a horizontal direction in FIG. 14). It is to be noted that the minimum width refers to a minimum width within a range of the thickness of the wavelength conversion member 122 (on the peripheral side surface 122S of the wavelength conversion member 122).

Preferably, a height h2 of the reflection layer 128 may be equal to at least a height (a thickness) of the wavelength conversion member 122.

It is to be noted that the height h2 of the reflection layer 128 refers to a maximum width in a direction parallel to the peripheral side surface 122S of the wavelength conversion member 122 (in a vertical direction in FIG. 14).

An example of a specification of the fluorescence emitting member 20c as described above may be as follows.

Dimensions of the substrate 121 may be 25 mm (longitudinal) by 25 mm (lateral) by 1.6 mm (thickness). Dimensions of the wavelength conversion member 122 may be 1.7 mm (longitudinal) by 3.0 mm (lateral) by 0.13 mm (thickness). Dimensions of the joining metal layer 129 may be 3.7 mm (longitudinal) by 5.0 mm (lateral) by 40 μm (thickness). The reflection layer 128 may have the thickness t of 1.0 mm and the height h2 of 0.14 mm. The uncovered region 129A of the joining metal layer 129 may be shaped as a rectangular frame with a width of 1 mm.

In the fluorescence-emitting light source unit 10 including the above-described fluorescence emitting member 20c, the excitation light L is emitted from the laser diode 10 as the laser light in the blue range. The excitation light L is allowed to be a parallel beam by the collimator lens 15. Then, the excitation light L passes through the dichroic mirror 16, and is applied substantially perpendicularly to the front surface 122F, i.e., the excitation light receiving surface of the wavelength conversion member 122. In the wavelength conversion member 122, the phosphor that constitutes the wavelength conversion member 122 is excited to emit the fluorescence L1. The fluorescence L1 exits through the front surface 122F, i.e., the fluorescence exiting surface of the wavelength conversion member 122, is reflected perpendicularly by the dichroic mirror 16, and exits to the outside of the fluorescence-emitting light source unit.

In the fluorescence-emitting light source unit 10, the reflection layer 128 covers the peripheral side surface 122S of the wavelength conversion member 122. This makes it possible to allow the fluorescence L1 exiting through the peripheral side surface 122S of the wavelength conversion member 122 to be reflected by the reflection layer 128 to return into an inside of the wavelength conversion member 122. Hence, it is possible to allow the fluorescence L1 generated inside the wavelength conversion member 122 to be extracted with high efficiency, resulting in high light emission efficiency.

Moreover, the wavelength conversion member 122 is joined to the front surface 121F of the substrate 121 with the joining metal layer 129 in between. Hence, it is possible to obtain a high heat exhaust property.

Furthermore, the reflection layer 128 is configured of the material in which the reflection particles are dispersed in the silicone resin, and such a material has low affinity for gold (Au) in general. However, the reflection layer 128 is provided on the uncovered region 129A of the joining metal layer 129. The constituent material of the reflection layer 128 has higher affinity for the constituent material of the joining metal layer 129 than for the constituent material of the front surface 121F of the substrate 121. Therefore, the reflection layer 128 is surely fixed to the uncovered region 129A of the joining metal layer 129, making it possible to restrain exfoliation of the reflection layer 128.

In addition, the thickness t of the reflection layer 128 is equal to or larger than 100 μm. This makes it possible to obtain even higher light emission efficiency.

Although description has been made by giving the third embodiment as mentioned above, the contents of the invention are not limited to the above-mentioned example embodiment and may be modified in a variety of ways.

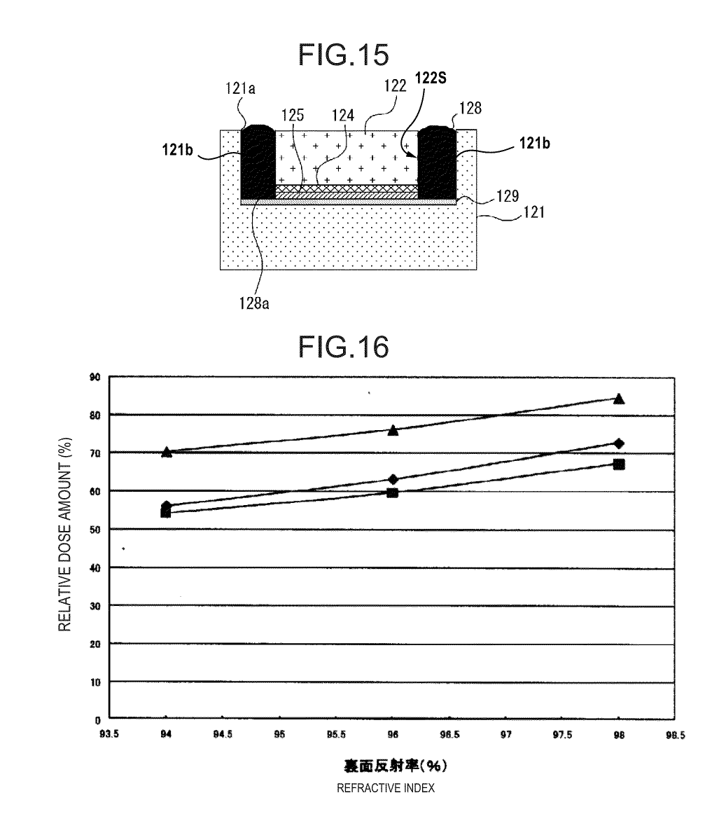

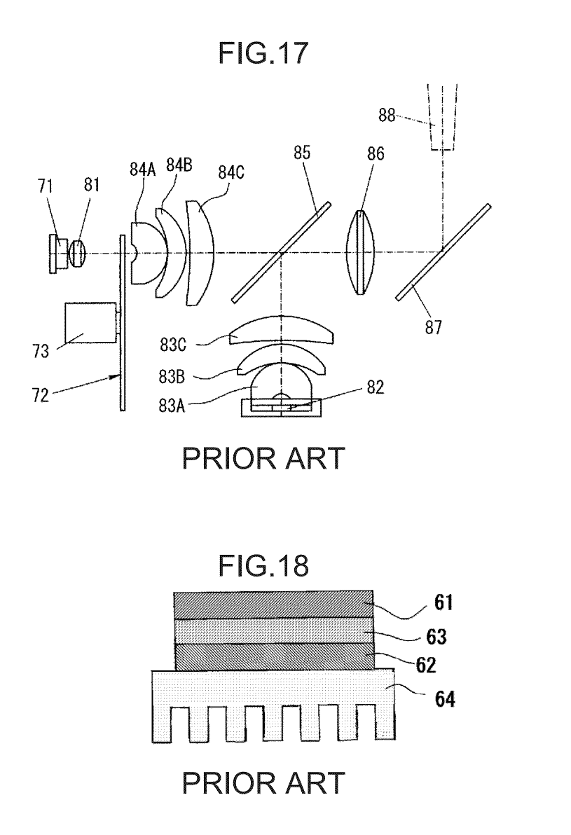

For example, as illustrated in FIG. 15, the substrate 121 in the fluorescence emitting member 20c may include a recess 121a. The wavelength conversion member 122 may be disposed in the recess 121a. The reflection layer 128 may be provided between an inner surface 121b of the recess 121a and the peripheral side surface 122S of the wavelength conversion member 122, in a state in which the constituent material of the reflection layer 128 is filled therebetween to form the reflection layer 128. With this configuration, it is possible to restrain the constituent material of the reflection layer 128 from flowing away when forming the reflection layer 128, and to form the reflection layer 128 while ensuring a uniform thickness. Hence, it is possible to obtain even higher light emission efficiency.

Moreover, for example, the uncovered region 129A of the joining metal layer 129 is not limited to a rectangular frame-shaped one.

Furthermore, the invention encompasses any possible combination of some or all of the various embodiments described herein and incorporated herein.

### EXAMPLES

In the following, some Experimental Examples of the invention are described. It should be understood that these Experimental Examples are illustrative, and should not be construed as being limiting in any way.

### Experimental Example 1-1

A fluorescence emitting member (A-1) including a front side cyclic structure having a specification as follows was fabricated, based on the configuration illustrated in FIG. 5.

### Substrate (31)

Material: an aluminum substrate,

Dimensions: 25 mm (longitudinal) by 25 mm (lateral) by 1 mm (thickness)

### Fluorescent Member (41)

Material: LuAG (refractive index=1.83, an excitation wavelength=445 nm, a fluorescent wavelength=535 nm),

Dimensions: 1.7 mm (longitudinal) by 3.0 mm (lateral) by 130 (thickness)

### Front Side Periodic Structural Layer (42)

Material: silicon nitride (refractive index=2.0),

Dimensions: 1.7 mm (longitudinal) by 3.0 mm (lateral) by 500 nm (thickness)

### Front Side Cyclic Structure (43)

Shape of protrusions (43a): circular conical,

Cycle (d1)=268 nm,

Height (h1) of the protrusion (43a)=500 nm

(A ratio (h1/d1) of the height (h1) of the protrusion (43a) to the cycle (d1)=2.0)

### Light Reflection Film (33)

Material: silver,

Thickness: 110 nm

A fluorescence emitting member (A-2) was fabricated that has similar configuration and specification to those of the fluorescence emitting member (A-1) except that no front side periodic structural layer was provided.

Excitation light having a peak wavelength of 445 nm was applied to an excitation light receiving surface (a front surface of the periodic structural layer) of the fluorescence emitting member (A-1), and to an excitation light receiving surface (a front surface of the fluorescent member) of the fluorescence emitting member (A-2). Light reflectance in each excitation light receiving surface was measured.

As a result, in the fluorescence emitting member (A-1), the light reflectance was 0.4%. On the other hand, in the fluorescence emitting member (A-2), the light reflectance was 15%. It was thus confirmed that backscattering of the excitation light was sufficiently restrained in the fluorescence emitting member (A-1).

### Experimental Example 1-2

A fluorescence emitting member (A-3) having a specification as follows was fabricated, in accordance with the configuration illustrated in FIG. 2.

### Substrate (31)

Material: an aluminum substrate,

Dimensions: 25 mm (longitudinal) by 25 mm (lateral) by 1 mm (thickness)

### Fluorescent Member (21)

Material: LuAG:Ce (refractive index=1.85, an excitation wavelength=450 nm, a fluorescent wavelength=530 nm),

Dimensions: 1.7 mm (longitudinal) by 3.0 mm (lateral) by 130 (thickness)

### Front Side Cyclic Structure (22):

Shape of protrusions (23): circular conical,

Cycle (d1)=292 nm,

A ratio (h1/d1) of the height (h1) of the protrusion (23) to the cycle (d1)=2.0

Rear Side Cyclic Structure (25):

Shape of protrusions (26): Semispherical, with a radius of 0.015 mm,

Cycle (d2)=0.03 mm,

Height (h) of the protrusions (26)=0.01 nm

### Light Reflection Film (33)

Material: silver,

Thickness: 110 nm

fluorescence emitting member (A-4) was fabricated that has similar configuration and specification to those of the fluorescence emitting member (A-3) except that no front side cyclic structure was provided. Also, a fluorescence emitting member (A-5) was fabricated that has similar configuration and specification to those of the fluorescence emitting member (A-3) except that no rear side cyclic structure was provided.

The excitation light having a peak wavelength of 445 nm was applied to each of excitation light receiving surfaces (front surfaces of the fluorescent members) of the fluorescence emitting members (A-3), (A-4), and (A-5). Light extraction efficiency in fluorescence exiting surfaces (the front surfaces of the fluorescent members), and light reflectance (rear surface reflectance) in rear surfaces (the rear surfaces of the fluorescent members) were measured. Results are indicated in FIG. 16. In FIG. 16, measurement values concerning the fluorescence emitting member (A-3) are indicated by triangular plots; measurement values concerning the fluorescence emitting member (A-4) are indicated by rhombic plots; and measurement values concerning the fluorescence emitting member (A-5) are indicated by rectangular plots.

As a result, it was confirmed that the light extraction efficiency was sufficiently enhanced in the fluorescence emitting member (A-3) owing to the rear surface cyclic structure.

In the fluorescence emitting member (A-3), for example, in a case with the rear surface reflectance of 98%, the light extraction efficiency was 84.7%. Thus, the fluorescence emitting member (A-3) achieved 1.25 times the light extraction efficiency of the fluorescence emitting member (A-5) in which the light extraction efficiency was 67.5% in a case with the rear surface reflectance of 98%.

### Experimental Example 2-1

A fluorescence emitting member (B-1) having a specification as follows was fabricated, in accordance with the configuration illustrated in FIG. 8.

### Substrate (31)

Material: an aluminum substrate,

Dimensions: 25 mm (longitudinal) by 25 mm (lateral) by 1 mm (thickness)

### Fluorescent Member (24)

Material: LuAG (refractive index=1.83, an excitation wavelength=445 nm, a fluorescent wavelength=535 nm),

Dimensions: 1.7 mm (longitudinal) by 3.0 mm (lateral) by 130 (thickness)

### Cyclic Structure (27)

Shape of protrusions (27a): circular conical,

Cycle (d)=600 nm,

Height (h) of the protrusions (27a)=600 nm

(An aspect ratio (h/d)=1.0)

### Light Reflection Film (29)

Material: a dielectric multi-layered film having a combination of SiO₂/TiO₂,

The total number of layers was 69 (A total thickness of SiO₂ layers was 3.3 and a total thickness of TiO₂ layers was 1.8 μm)

Reflectance in a wavelength range from 425 nm to 600 nm both inclusive was 99% or more.

### Experimental Example 2-2

A fluorescence emitting member (B-2) was fabricated that has similar configuration and specification to those of the fluorescence emitting member (B-1) except that the reflectance of the dielectric multi-layered film was 98% in Example 2-1.

### Comparative Example 1

A fluorescence emitting member (1) was fabricated that has similar configuration and specification to those of the fluorescence emitting member (B-1) except that the light reflection film on the rear surface was configured of a single-layer film made of silver and having reflectance of 96% in Example 2-1.

### Comparative Example 2

A fluorescence emitting member (2) was fabricated that has similar configuration and specification to those of the fluorescence emitting member (1) except that the light reflection film on the rear surface was configured of a single-layer film made of an Ag/Pd/Cu alloy and having reflectance of 94% in Comparative Example 1.

The excitation light having a peak wavelength of 445 nm was applied to each of excitation light receiving surfaces (front surfaces of the fluorescent members) of the fluorescence emitting members (B-1), (B-2), (1), and (2). Light reflectance in rear surfaces of the fluorescent members and fluorescence extraction efficiency from the fluorescent members were measured. Results are summarized in Table 1.

TABLE 1

| | | | Rear Surface | Extraction |
|---|---|---|---|---|
| | | Reflection | Reflectance | Efficiency |
| | | Film | (%) | (%) |
| Experimental | Fluorescence | Multi-layered | 99 | 71.5 |
| Example 2-1 | Emitting | Film | | |
| | Member (B-1) | | | |
| Experimental | Fluorescence | | 98 | 67.5 |
| Example 2-2 | Emitting | | | |
| | Member (B-2) | | | |
| Comparative | Fluorescence | Single-layer | 96 | 59.6 |
| Example 1 | Emitting | Film | | |
| | Member (1) | | | |
| Comparative | Fluorescence | | 94 | 54.2 |
| Example 2 | Emitting | | | |
| | Member (2) | | | |

From the results in Table 1, the following was confirmed. When the light reflection film formed on the rear surface of the fluorescent member was configured of a dielectric multi-layered film, it was possible to enhance light extraction efficiency from the fluorescent member, as compared to a case with the light reflection film made of silver.

### Experimental Example 3-1

A fluorescence emitting member (C-1) having a specification as follows was fabricated, in accordance with the configuration illustrated in FIGS. 13 and 14.

### Substrate (121)

Material: an aluminum substrate,

Dimensions: 25 mm (longitudinal) by 25 mm (lateral) by 1.6 mm (thickness)

On the aluminum substrate, a nickel/gold (Ni/Au=2.5 μm/300 nm) film was formed.

### Wavelength Conversion Member (122)

Material: LuAG (refractive index=1.83, an excitation wavelength=445 nm, a fluorescent wavelength=535 nm),

Dimensions: 1.7 mm (longitudinal) by 3.0 mm (lateral) by 0.13 mm (thickness)

Cyclic Structure on a Front Surface

Deposition Material: Ta₂O₅

Cycle: 460 nm

Height: 460 nm

Shape: Substantially circular conical.

A light reflection film (124) and a metal film (125) were formed on a lower surface of LuAG.

### Light Reflection Film (124)

Material: a dielectric multi-layered film having a combination of SiO₂/TiO₂,

The total number of layers was 69 (A total thickness of SiO₂ layers was 3.3 and a total thickness of TiO₂ layers was 1.8 μm)

Reflectance in a wavelength range from 425 nm to 600 nm both inclusive was 98% or more.

### Metal Film (125)

Material: nickel/platinum/gold (Ni/Pt/Au=30 nm/500 nm/500 nm)

[Joining Metal Layer (129)]

Material: solder (Sn—Ag—Cu), a melting point=260° C.

Dimensions: 3.7 mm (longitudinal) by 5.0 mm (lateral) by 40 (thickness)

Dimension (shape) of an uncovered region (129A): a rectangular frame with a width of 1 mm

### Reflection Film (128)

Material: TiO₂ dispersed in a silicone resin (a particle diameter of reflection particles=500 nm to 5000 nm both inclusive, and a content ratio was 2 mass % to 4 mass % both inclusive)

Thickness (t): 100

Height (h2): 0.14 mm

### Experimental Example 3-2

A fluorescence emitting member (C-2) was fabricated that has similar configuration and specification to those of the fluorescence emitting member (C-1) except that the thickness (t) of the reflection layer (128) was changed to 20 μm in Example 3-1.

### Comparative Example 3

A fluorescence emitting member (3) was fabricated that has similar configuration and specification to those of the fluorescence emitting member (C-1) except that no reflection film (128) was provided in Example 3-1.

The excitation light having a peak wavelength of 445 nm was applied to each of excitation light receiving surfaces (front surfaces of the wavelength conversion members) of the fluorescence emitting members (C-1), (C-2), and (3). Fluorescence extraction efficiency from each of the wavelength conversion members was measured. Results are summarized in Table 2.

TABLE 2

| | | Thickness of | |
|---|---|---|---|
| | | Reflection Film | Extraction |
| | | (μm) | Efficiency (%) |
| Experimental | Fluorescence | 100 | 80 |
| Example 3-1 | Emitting Member | | |
| | (C-1) | | |
| Experimental | Fluorescence | 20 | 67 |
| Example 3-2 | Emitting Member | | |
| | (C-2) | | |
| Comparative | Fluorescence | Not provided | 59 |
| Example 3 | Emitting Member | | |
| | (3) | | |

### Comparative Example 4

A fluorescence emitting member (4) was fabricated that has similar configuration and specification to those of the fluorescence emitting member (C-1) except that a barium sulfate layer was formed instead of the joining metal layer (129) in Example 3-1.

The excitation light having a peak wavelength of 445 nm was applied to each of excitation light receiving surfaces (front surfaces of the wavelength conversion members) of the fluorescence emitting members (C-1) and (4). A temperature of a front surface (121F) of the substrate (121) was measured with use of a thermocouple. Based on measurement values thus obtained and thermal resistance of each of the wavelength conversion members, a temperature of the wavelength conversion member (122) was calculated. Results are summarized in Table 3.

TABLE 3

| | | Temperature of |
|---|---|---|
| | | Wavelength |
| | | Conversion |
| | | Member (° C.) |
| Experimental Example 3-1 | Fluorescence Emitting | 148 |
| | Member (C-1) | |
| Comparative Example 4 | Fluorescence Emitting | 237 |
| | Member (4) | |

### Comparative Example 5

A fluorescence emitting member (5) was fabricated that has similar configuration and specification to those of the fluorescence emitting member (C-1) except that no uncovered region (129A) of the joining metal layer (129) was formed, and the reflection layer (128) was provided directly on the substrate (121) in Example 3-1.

As to the fluorescence emitting members (C-1), (C-2), and (5), it was examined whether or not the reflection film (128) was exfoliated.

As a result, no exfoliation was observed in the fluorescence emitting members (C-1) and (C-2). On the other hand, in the fluorescence emitting member (5), exfoliation from the substrate (121) was observed.

From the results described above, it was confirmed that the fluorescence generated in the wavelength conversion member (122) was extracted with high efficiency, when the reflection film (128) was formed so as to cover the peripheral side surface (122S) of the wavelength conversion member (122). It was also confirmed that the fluorescence extraction efficiency became higher as the thickness of the reflection layer (128) increased.

Moreover, it was confirmed that a higher heat exhaust property was obtained when the wavelength conversion member (122) was joined with the joining metal layer (129) in between, as compared to a case with a barium sulfate layer in between.

Furthermore, it was confirmed that the reflection layer (128) was surely fixed to the uncovered region (129A) of the joining metal layer (129), restraining exfoliation of the reflection layer (128), when the reflection layer (128) was provided on the uncovered region (129A) of the joining metal layer (129) and the constituent material of the reflection layer (128) had higher affinity for the constituent material of the joining metal layer (129) than for the constituent material of the front surface (121F) of the substrate (121).

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A fluorescence-emitting light source unit, comprising:
a wavelength conversion member including a front surface as a light receiving surface configured to receive an excitation light, a phosphor, and a rear surface, the front surface being provided with a front side cyclic structure, the phosphor being configured to convert the excitation light received in the light receiving surface to fluorescence and to emit the fluorescence, and the rear surface being provided with a rear side cyclic structure; and
a light reflection surface provided on an outer side of the rear surface.

2. The fluorescence-emitting light source unit according to claim 1,
wherein a cycle of the front side cyclic structure is of a size in a range in which diffraction of the fluorescence emitted from the phosphor occurs.

3. The fluorescence-emitting light source unit according to claim 1,
wherein a cycle of the rear side cyclic structure is of a size in a range in which diffraction of the fluorescence emitted from the phosphor occurs.

4. The fluorescence-emitting light source unit according to claim 1,
wherein the wavelength conversion member is configured of a fluorescent member including the phosphor.

5. The fluorescence-emitting light source unit according to claim 1,
wherein the wavelength conversion member comprises:
a fluorescent member including the phosphor; and
one or both of a front side periodic structural layer and a rear side periodic structural layer, the front side periodic structural layer being provided on a front surface of the fluorescent member and including the front side cyclic structure, and the rear side periodic structural layer being provided on a rear surface of the fluorescent member and including the rear side cyclic structure.

6. The fluorescence-emitting light source unit according to claim 5,
wherein a refractive index of the front side periodic structural layer and a refractive index of the rear side periodic structural layer are equal to or higher than a refractive index of the fluorescent member.

7. A fluorescence-emitting light source unit, comprising:
a wavelength conversion member including a front surface as a light receiving surface to receive excitation light, a phosphor, and a rear surface as a light diffusing surface, the front surface being provided with a front side cyclic structure including a plurality of first protrusions arranged periodically, the phosphor being configured to convert the excitation light received in the light receiving surface to fluorescence and to emit the fluorescence, and the rear surface being configured of a rough surface; and
a light reflection surface provided on an outer side of the rear surface.

8. A fluorescence-emitting light source unit, comprising:
a wavelength conversion member including a front surface as a light receiving surface configured to receive an excitation light, a phosphor, and a rear surface, the front surface being provided with a cyclic structure including a plurality of substantially conical protrusions arranged periodically, the phosphor being configured to convert the excitation light received in the light receiving surface to fluorescence and to emit the fluorescence; and
a light reflection film configured of a dielectric multi-layered film and provided on the rear surface,
wherein a cycle of the cyclic structure is of a size in a range in which diffraction of the fluorescence emitted from the phosphor occurs.

9. The fluorescence-emitting light source unit according to claim 8,
wherein the wavelength conversion member includes a peripheral side surface surrounded by a reflection surface.

10. The fluorescence-emitting light source unit according to claim 9,
wherein the reflection surface surrounding the peripheral side surface of the wavelength conversion member is a diffusion reflection surface.

11. A fluorescence-emitting light source unit, comprising:
a substrate including a front surface;
a joining metal layer;
a wavelength conversion member that covers a portion of the joining metal layer, is joined to the front surface of the substrate with the joining metal layer in between, and includes a peripheral side surface; and
a reflection layer including a binder and reflection particles dispersed in the binder, the reflection layer covering a part or all of a portion of the joining metal layer other than the portion covered with the wavelength conversion member and covering the peripheral side surface of the wavelength conversion member,
wherein a constituent material of the reflection layer has higher affinity for a constituent material of the joining metal layer than for a constituent material of the front surface of the substrate.

12. The fluorescence-emitting light source unit according to claim 11,
wherein the reflection layer is of a thickness equal to or larger than 100 μm.

13. The fluorescence-emitting light source unit according to claim 11,
wherein the substrate includes a recess that includes an inner surface,
the wavelength conversion member is disposed in the recess, and
the reflection layer is provided between the inner surface of the recess and the peripheral side surface of the wavelength conversion member.
